(19) United States
(12) Patent Application Publication
(10) Pub. No.: US 2026/0362038 A1
(43) Pub. Date: Nov. 12, 2026

(54) DUAL-MODE NETWORK INTERFACE CONTROLLER

(71) Applicant: MELLANOX TECHNOLOGIES, LTD., Yokneam (IL)

(72) Inventors: Aleksey Dyskin, Haifa (IL); Elad Mentovich, Tel Aviv (IL)

(21) Appl. No.: 19/200,608

(22) Filed: May 6, 2025

(51) Int. Cl. H04Q 11/00; H04B 10/079

(52) U.S. Cl. CPC H04Q 11/0005; H04B 10/0795; H04Q 11/0062; H04Q 2011/0064

(57) ABSTRACT

A device and method for a hybrid network interface controller (NIC) that integrates both optical and wireless communication interfaces and includes intelligent control circuitry for dynamically selecting or concurrently utilizing one or both interfaces based on real-time operational conditions. The NIC includes a controller and, in some embodiments, a machine-learning model configured to evaluate workload information and communication medium performance data to generate configuration directives. These directives are used to activate, deactivate, or modify the behavior of the optical and wireless interfaces, thereby optimizing link selection, performance, or energy efficiency. The hybrid NIC can operate autonomously based on local thresholds, leverage model-driven decision-making, or accept configuration commands from an external orchestrator. This architecture enables dynamic, per-flow or system-wide media selection that enhances network adaptability, reliability, and performance in heterogeneous or high-demand computing environments.

### FIELD OF THE DISCLOSURE

The present disclosure is generally directed toward networking and, in particular, toward networking devices and methods of operating the same.

### BACKGROUND

High-performance computing environments, cloud data centers, and edge computing infrastructures often rely on increasingly complex network interface technologies to meet escalating demands for bandwidth, latency sensitivity, and different workloads. Traditional network interface controllers (NICs) may be equipped with wired communication interfaces, such as Ethernet or optical transceivers, which provide reliable and high-throughput data transmission for a wide range of applications. Wireless communication technologies have also advanced significantly, providing increased data rates, reduced latency, and improved reliability through standards such as Wi-Fi 6/6E, 5G, and emerging millimeter-wave protocols. Such capabilities have enabled wireless communication to provide a viable complement to wired networking in certain performance-critical and flexible deployment scenarios.

Despite these advances, modern network workloads continue to exhibit variability in terms of bandwidth requirements, latency constraints, mobility, and availability expectations. As a result, system designers must often evaluate trade-offs between different communication interfaces and manage transitions or failovers between them, which can introduce complexity and inefficiencies. Accordingly, improvements are needed in how network architectures can manage communication and support the demands of changing compute and networking systems.

### GENERAL DESCRIPTION

In accordance with at least some aspects of the present disclosure, methods and systems are directed to a hybrid network interface controller (NIC) that integrates both optical and wireless communication interfaces and includes intelligent control circuitry for dynamically selecting or concurrently utilizing one or both interfaces based on real-time operational conditions enabling data centers to seamlessly choose between optical and wireless links without requiring manual reconfiguration or complex network management. In some aspects, determining when to shift traffic to the most efficient link (e.g., optical or wired) can be based on monitored link conditions (e.g., signal strength and bandwidth usage) and workload demands. As a result, data centers can adapt to changing workloads and high priority demands, reducing downtime and ensuring bandwidth is used more effectively across large-scale deployments. The NIC includes a controller and, in some embodiments, a machine-learning model configured to evaluate workload information and communication medium performance data to generate configuration directives. These directives are used to activate, deactivate, or modify the behavior of the optical and wireless interfaces, thereby optimizing link selection, performance, or energy efficiency. The hybrid NIC can operate autonomously based on local thresholds, leverage model-driven decision-making, or accept configuration commands from an external orchestrator. This architecture enables dynamic, per-flow or system-wide media selection that enhances network adaptability, reliability, and performance in heterogeneous or high-demand computing environments.

Example aspects of the present disclosure provide a network interface device. In some aspects, the network interface device comprises: an optical interface to communicate data via an optical communication medium; a wireless interface to communicate data via a wireless communication medium; and one or more circuits to selectively route data from a host device to at least one of the optical interface or the wireless interface in response to a threshold condition.

Aspects include wherein the one or more circuits are further to at least one of: switch data transmission from a first communication medium to a second communication medium; or enable both communication media concurrently.

Aspects include wherein the one or more circuits are further to route data via both the optical interface and the wireless interface in response to the threshold condition.

Aspects include wherein the threshold condition is based on at least one of: a measured communication link quality metric associated with at least one of the optical communication medium or the wireless communication medium; a measure of bandwidth utilization associated with at least one of the optical communication medium or the wireless communication medium; a detected bit-error rate associated with at least one of the optical communication medium or the wireless communication medium; or a signal-to-noise ratio associated with at least one of the optical communication medium or the wireless communication medium.

Aspects include wherein the one or more circuits are further to: receive an indication of a workload demand; and compare the indication of the workload demand to the threshold condition.

Aspects include wherein the one or more circuits are further to: route high-priority workload traffic through the optical interface; and route lower-priority workload traffic through the wireless interface.

Aspects include wherein the one or more circuits include a local memory storing artificial intelligence (AI)-based decision logic, and the threshold condition is determined by the AI-based decision logic in response to usage metrics collected from the optical interface and the wireless interface.

Aspects include wherein the threshold condition is triggered in response to receiving a switching command from an external orchestration controller in a data center network.

Aspects include wherein the network interface device may include an interface to couple the network interface device to the host device, wherein the interface is further to communicate with the host device using at least one of an optical pathway or an electrical pathway.

Aspects include wherein the wireless interface comprises at least one of: a photonic mixing stage to generate optical signal; or a radio frequency mixing stage configured to generate or receive millimeter-wave or terahertz signals.

Aspects include wherein the network interface device may include a photonic signal generator to generate a modulated optical signal; and a branching module to direct the modulated optical signal to at least one of the optical interface or the wireless interface.

Aspects include wherein the network interface device may include an optical output coupling the modulated optical signal to an optical fiber.

Aspects include wherein the wireless interface includes: a photonic mixing stage to generate a millimeter-wave or terahertz signals; and an antenna coupled to the photonic mixing stage.

Aspects include wherein the controller is to adaptively adjust operation of the network interface device based on at least one of real-time network conditions or workload demands, including at least one of modifying data routing logic, selecting between communication media, or reallocating bandwidth across the optical and wireless interfaces.

Example aspects of the present disclosure provide a network interface device. In some aspects, the network interface device comprises an optical interface to receive a modulated optical signal; optical processing circuitry to demodulate the modulated optical; a wireless interface to receive a wireless signal; wireless processing circuitry to decode the wireless signal; and one or more output circuits coupled to the optical processing circuitry and the wireless processing circuitry, the one or more output circuits to provide demodulated data to a host system.

Aspects include wherein the network interface device includes a controller communicatively coupled to the optical processing circuitry and the wireless processing circuitry, the controller to: monitor at least one link-quality metric associated with the optical interface and the wireless interface; and selectively enable or disable reception through at least one of the optical interface or wireless interface based on a threshold condition.

Aspects include wherein the controller is further to receive data concurrently over the optical interface and the wireless interface in response to detecting that at least one of an overall bandwidth demand or a link utilization meets or exceeds the threshold condition.

Aspects include wherein the controller comprises artificial intelligence (AI)-based decision logic to modify the threshold condition based on the at least one link-quality metric.

Example aspects of the present disclosure provide a system. In some aspects, the system comprises: a host device to generate outgoing data traffic; a network interface device communicatively coupled to the host device, the network interface device comprising: an optical interface to transmit data over an optical communication medium, a wireless interface to transmit data over a wireless communication medium, and a controller to selectively route the outgoing data traffic between the optical interface and the wireless interface based on a threshold condition.

Aspects include wherein the network interface device further comprises: optical processing circuitry to demodulate inbound optical signals from the optical communication medium; and wireless processing circuitry to decode inbound wireless signals from the wireless communication medium, and wherein the controller is further to route incoming data to the host device.

Aspects include wherein the controller comprises an artificial intelligence module to: monitor link performance metrics from the optical interface and the wireless interface; and dynamically adjust the threshold condition in response to changes in the link performance metrics.

Aspects include wherein the host device comprises a workload manager that assigns a priority indicator to outgoing data, and the controller is to route higher-priority traffic over the optical interface and lower-priority traffic over the wireless interface.

Example aspects of the present disclosure provide a hybrid network switch. In some aspects, the hybrid network switch comprises: a plurality of wired ports to transmit and receive data over physical cabling; a plurality of wireless ports to transmit and receive data over a wireless communication medium; and switching hardware coupled to the wired ports and the wireless ports, the switching hardware to direct data from an ingress port to a selected egress port based on routing or switching logic.

Additional features and advantages are described herein and will be apparent from the following Detailed Description and the figures.

### BRIEF DESCRIPTION OF THE SEVERAL VIEWS OF THE DRAWINGS

The present disclosure is described in conjunction with the appended figures, which are not necessarily drawn to scale:

FIG. 1A depicts a block diagram of a hybrid network interface controller with optical and wireless interfaces in accordance with at least one aspect of the present disclosure;

FIG. 1B depicts a block diagram of another hybrid network interface controller with optical and wireless interfaces in accordance with at least one aspect of the present disclosure;

FIG. 2A depicts a block diagram of a controller with a model-based communication medium selector in accordance with at least one aspect of the present disclosure;

FIG. 2B depicts a block diagram of a controller with an externally configured communication medium selector in accordance with at least one aspect of the present disclosure;

FIG. 2C depicts a block diagram of an external configuration generation system for controlling interface selection in accordance with at least one aspect of the present disclosure;

FIG. 2D depicts data structures in accordance with at least one aspect of the present disclosure;

FIG. 3A depicts a block diagram of a training system for generating a machine-learning model in accordance with at least one aspect of the present disclosure;

FIG. 3B depicts a block diagram of a neural network architecture in accordance with at least one aspect of the present disclosure;

FIG. 4A depicts a block diagram of an optical module with transmit and receive paths in accordance with at least one aspect of the present disclosure;

FIG. 4B depicts a block diagram of a wireless module with transmit and receive paths in accordance with at least one aspect of the present disclosure;

FIG. 4C depicts a block diagram of a photonic-based wireless module using optical mixing for signal generation in accordance with at least one aspect of the present disclosure;

FIG. 4D depicts a block diagram of a hybrid optical transmission system with selective output routing in accordance with at least one aspect of the present disclosure;

FIG. 4E depicts a block diagram of a photonic mixing stage in accordance with at least one aspect of the present disclosure;

FIG. 5A depicts a flowchart of a method for dynamically selecting or modifying active communication interfaces in accordance with at least one aspect of the present disclosure;

FIG. 5B depicts a flowchart of a method for generating communication interface configuration output using a decision model in accordance with at least one aspect of the present disclosure;

FIG. 5C depicts a flowchart of a method for applying a configuration output to a hybrid network interface controller in accordance with at least one aspect of the present disclosure;

FIG. 6 depicts a flowchart of an exemplary method for dynamically selecting between optical and wireless communication interfaces in accordance with at least one aspect of the present disclosure;

FIG. 7A illustrates a block diagram of a system that includes switching circuitry positioned between first and second sets of devices, in accordance with at least one embodiment;

FIG. 7B illustrates a block diagram of a hybrid network switch in accordance with aspects of the present disclosure;

FIG. 8 illustrates a block diagram of an example system, in accordance with at least one embodiment;

FIG. 9 illustrates an example data center, in accordance with at least one embodiment;

FIG. 10 illustrates a processing system, in accordance with at least one embodiment;

FIG. 11 illustrates a computer system, in accordance with at least one embodiment;

FIG. 12 illustrates a system, in accordance with at least one embodiment;

FIG. 13 illustrates an example integrated circuit, in accordance with at least one embodiment; and

FIG. 14 illustrates a computing system, according to at least one embodiment.

Like reference numbers and designations in the various drawings indicate like elements.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It is understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not to be deemed “material.”

The terms “determine,” “calculate,” and “compute,” and variations thereof, as used herein, are used interchangeably, and include any appropriate type of methodology, process, operation, or technique.

Various aspects of the present disclosure will be described herein with reference to drawings that are schematic illustrations of idealized configurations. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

Aspects of the present disclosure are directed to apparatuses, methods, processing systems, and computer-readable mediums for dynamically selecting between multiple communication media in network interface devices. In some aspects, data centers and high-performance computing environments may use flexible networking solutions that can adapt to diverse workloads and changing network conditions. Aspects of the present disclosure describe a dual-mode hybrid NIC that integrates both optical and wireless communication interfaces with control circuitry that selects a communication medium based on real-time conditions and requirements. In some aspects, network interface devices may be limited to a single communication medium, making them unable to adapt to varying network conditions, congestion, or changing workload demands. This inflexibility can lead to suboptimal performance when the primary medium experiences degradation, bandwidth constraints, or latency issues. Additionally, conventional network architectures often require manual reconfiguration or complex orchestration to switch between different communication media, resulting in operational inefficiencies and potential service disruptions.

Aspects of the present disclosure addresses these challenges by providing a hybrid network interface device, where the hybrid network interface device may be the same as or similar to a hybrid network interface controller, that incorporates both optical and wireless communication interfaces controlled by selection circuitry. In some aspects, the hybrid architecture provides automatic dynamic switching between communication media (e.g. optical (fiber) and wireless connections) based on real-time network conditions, real-time performance metrics, workload characteristics and demands, and resource utilization ensuring seamless, high-performance connectivity in data centers. In some aspects, an artificial intelligence (AI) module monitors link quality metrics, bandwidth requirements, and workload priorities, and adjusts threshold conditions to modify routing by the hybrid network interface device. The hybrid network interface device may operate in multiple modes, including single-medium operation, concurrent dual-medium operation for load balancing, or priority-based traffic routing across different media.

A technical solution provides several advantages over conventional approaches. For example, aspects of the present disclosure improve network resilience by automatically rerouting traffic when one communication medium experiences degradation, preventing service interruptions and maintaining connectivity. As another example, aspects of the present disclosure my optimize resource utilization by distributing traffic across available media based on workload characteristics and current network conditions, thereby improving overall system efficiency. As another example, an AI-based decision logic can be used to improve optimize performance based on historical patterns and learned relationships between network conditions and application requirements. As another example, the hybrid network interface device improves deployment flexibility within diverse environments where different communication media may have their own advantages, allowing a system to select an optimal path for each specific workload or operating condition.

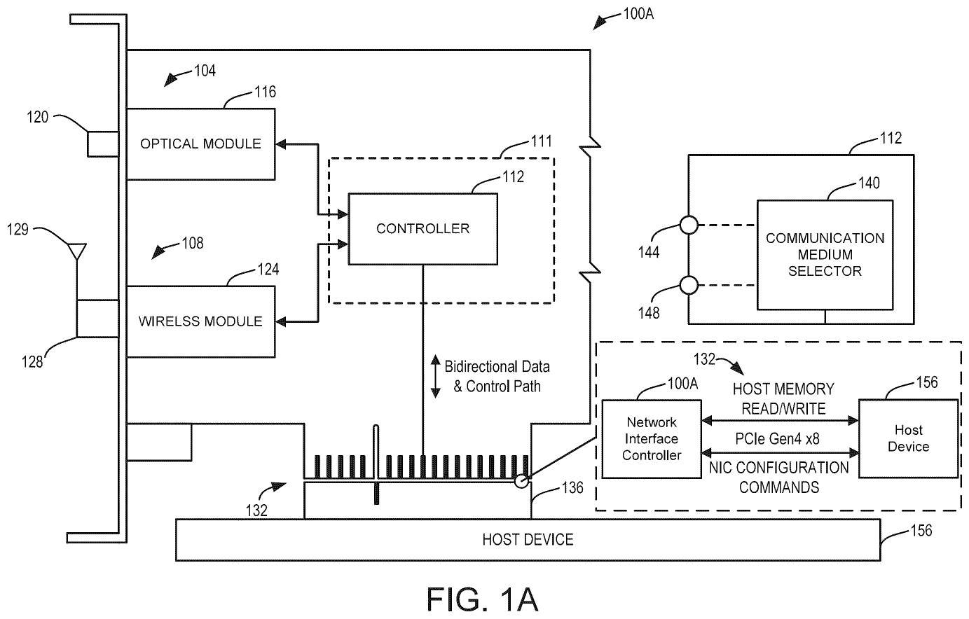

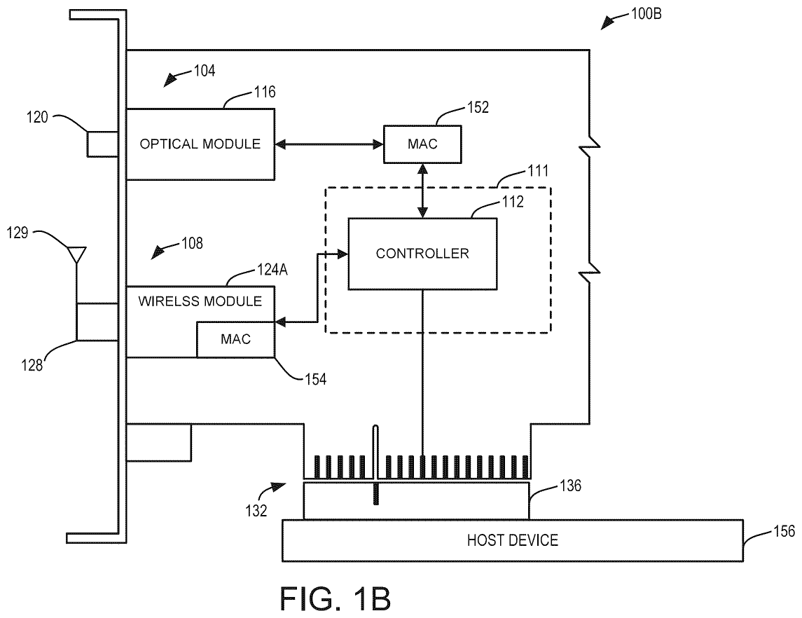

FIG. 1A depicts an example of a network interface device 100A that is configured to communicate with a host system 156 using a plurality of communication media in accordance with at least one aspect of the present disclosure. The network interface device 100A may be implemented by a hybrid network interface controller being a pluggable module, expansion card, or embedded interface device in a computing system. The hybrid network interface controller 100A enables dynamic selection between optical and wireless communication channels, providing flexibility, redundancy, and performance adaptation based on system conditions or operational requirements.

In some aspects, the hybrid network interface controller 100A includes an optical interface 104 and a wireless interface 108. In some aspects, the optical interface 104 may include an optical module 116 and an optical connector interface 120. The optical module 116 may include circuitry configured to transmit and receive optical signals via an optical communication medium, such as an optical fiber. The optical module 116 may include various optical components including, but not limited to, one or more laser diodes for signal generation, photodetectors for optical signal reception, optical modulators for encoding data onto light signals, demodulators for recovering data from received optical signals and signal conditioning components for ensuring signal integrity. The optical module 116 may be configured to support various optical transmission standards and protocols, including but not limited to Ethernet, Fibre Channel, InfiniBand, or proprietary protocols. In some implementations, the optical module 116 may incorporate integrated photonic circuits, silicon photonics, or other advanced optical technologies to minimize size, power consumption, or latency. The optical interface 104 may include diagnostic capabilities to monitor optical power levels, wavelength stability, or bit error rates.

The optical connector interface 120 may be configured to couple the optical module 116 to an external optical cable. The optical connector interface 120 may be compatible with industry-standard optical connectors such as LC (Lucent Connector), SC (Subscriber Connector), MPO (Multi-fiber Push-On), or other suitable optical connectors. In some implementations, the optical module 116 may be designed as a pluggable transceiver module compliant with industry standards such as SFP (Small Form-factor Pluggable), QSFP (Quad Small Form-factor Pluggable), or OSFP (Octal Small Form-factor Pluggable).

In some aspects, the wireless interface 108 comprises a wireless module 124 and a wireless connector interface 128. The wireless module 124 may include circuitry configured to transmit and receive wireless signals via a wireless communication medium. Wireless communication may utilize various frequency bands and protocols, including but not limited to millimeter-wave (e.g., 30-300 GHz), terahertz (e.g., 0.1-10 THz), or other radio-frequency bands suitable for high-bandwidth, short-range communication. The wireless module 124 may include one or more radio frequency (RF) front-end components such as power amplifiers, low-noise amplifiers, mixers, filters, and/or oscillators. Such components may process the RF signals used in wireless communication. The wireless module 124 may also include baseband processors that handle digital signal processing functions such as modulation, demodulation, encoding, decoding, error correction, and/or protocol processing. The wireless module 124 may also incorporate media access control (MAC) logic to manage channel access, addressing, and frame formatting according to wireless communication protocols.

The wireless connector interface 128 may be configured to couple the wireless module 124 to one or more antenna elements 129 or waveguides. In some aspects, the antenna elements 129 or waveguides may be internal to the card enclosure and/or comprise external components connected via suitable RF connectors. The antenna elements 129 may be configured for directional transmission to enhance signal strength in specific directions or omnidirectional coverage for broader connectivity. In some aspects, the wireless interface 108 may utilize beamforming techniques with phased array antennas to direct a wireless signal toward one or more target receivers to improve signal quality and reduce interference.

In some aspects, the controller 112 may be communicatively coupled to the optical interface 104 and the wireless interface 108. The controller 112 may include logic configured to route data traffic to either the optical module 116 or the wireless module 124 based on communication policies, performance metrics, or channel conditions. In some implementations, the controller 112 is at least partially resident within a local memory 111. As used herein, local memory may refer to one or more memory components located on or integrated with the network interface controller hardware, which may store executable firmware, logic state, decision-making rules, or configuration parameters for real-time operation. In some aspects, the controller 112 may execute or access operational instructions directly from the local memory 111, providing access to link monitoring data, threshold values, or routing logic without requiring interaction with the host system memory or external orchestrators. In some aspects, the controller 112 includes or communicates with a communication medium selector 140, which is configured to select one or both of available communication paths (e.g., optical and/or wireless). The communication medium selector 140 may incorporate decision logic that evaluates one or more operational parameters to determine an optimal communication medium based on current conditions. In some aspects, the operational parameters may include, but are not limited to, bandwidth requirements, latency constraints, error rates, signal strength, power consumption targets, or application-specific quality of service requirements.

As further illustrated in FIG. 1A, the controller 112 may include or be operatively associated with selectors 144 and 148. Selector 144 corresponds to the optical communication path, and selector 148 corresponds to the wireless communication path. The selector 144 and selector 148 may be implemented through various mechanisms, including but not limited to, electrical switches, software-defined logic gates, and/or routing rules that determine which interface is actively used to transmit/receive data to/from the host system 156 and/or which interface is actively used to transmit/receive data to/from another communication device.

In some implementations, the selector 144 and selector 148 may operate in a mutually exclusive manner, activating either the optical interface 104 or the wireless interface 108. In other implementations, both selector 144 and selector 148 may be activated simultaneously to enable concurrent data transmission or reception through the optical interface 104 and the wireless interface 108. This concurrent operation may support load balancing, data redundancy, or channel bonding to increase aggregate bandwidth.

In some aspects, the coupling interface 132 is configured to physically and electrically couple the hybrid network interface controller 100A to a host system 156. The coupling interface 132 may provide a communication pathway between the network interface controller and the host system 156 with which it is installed and/or otherwise in communication. In some aspects, the coupling interface 132 may include a peripheral component interconnect express (PCIe) interface, an edge connector, or any suitable bus connector compatible with host system interfaces, such as a host system interface 136. The coupling interface 132 may support various communication protocols and standards for host integration, including but not limited to PCIe, CXL (Compute Express Link), or proprietary interconnect technologies. In some aspects, the coupling interface 132 is configured to exchange bidirectional data and control signals with a host device 156. The coupling interface 132 may include a PCIe Gen4 x8 connection or other suitable interconnect, supporting memory read/write operations and configuration commands. The inset depicted in FIG. 1A shows logical communication between the NIC and the host device 156, enabling workload-aware routing and real-time performance adaptation.

In some aspects, the host system 156 represents the computing platform that utilizes the hybrid network interface controller 100A for network communications. In some aspects, the host system 156 may be a server, storage system, networking equipment, or other computing device utilizing network connectivity. In some aspects, the host system 156 communicates with the hybrid network interface controller 100A through the coupling interface 132, sending outbound data for transmission and receiving inbound data from network connections.

FIG. 1B illustrates another example of a hybrid network interface controller 100B in accordance with at least some aspects of the present disclosure. The hybrid network interface controller 100B may include the optical interface 104 and the wireless interface 108, each communicatively coupled to the controller 112. The hybrid network interface controller 100B may be electrically and physically coupled to a host system 156 through the coupling interface 132. In some aspects, the optical interface 104 may be associated with a MAC circuit 152, which is communicatively coupled to both the optical module 116 and the controller 112. In some aspects, the MAC circuit 152 performs data link layer functions for the optical communication path. The MAC circuit 152 may be implemented as a dedicated digital logic block, an application-specific integrated circuit (ASIC), a field-programmable gate array (FPGA), or as firmware executed by a microcontroller or processor. The MAC circuit 152, in some aspects, performs functions including Ethernet or other protocol framing, packet encapsulation, error detection and correction, flow control, and media arbitration. In some aspects, the MAC circuit 152 provides an abstraction layer between the physical layer functions performed by the optical module 116 and higher-layer protocol handling that may occur in the controller 112 or host system 156.

In some aspects, the wireless module 124A may be associated with a wireless MAC circuit 154. The wireless MAC circuit 154 may implement protocol-specific logic for various wireless communication standards, including Wi-Fi (IEEE 802.11 family), 5G NR (New Radio), millimeter-wave protocols, or other wireless technologies suitable for high-speed data transmission. The wireless MAC circuit 154 may support wireless-specific tasks such as frame generation and processing, retransmission management, acknowledgment handling, encryption and security protocols, and wireless channel access coordination.

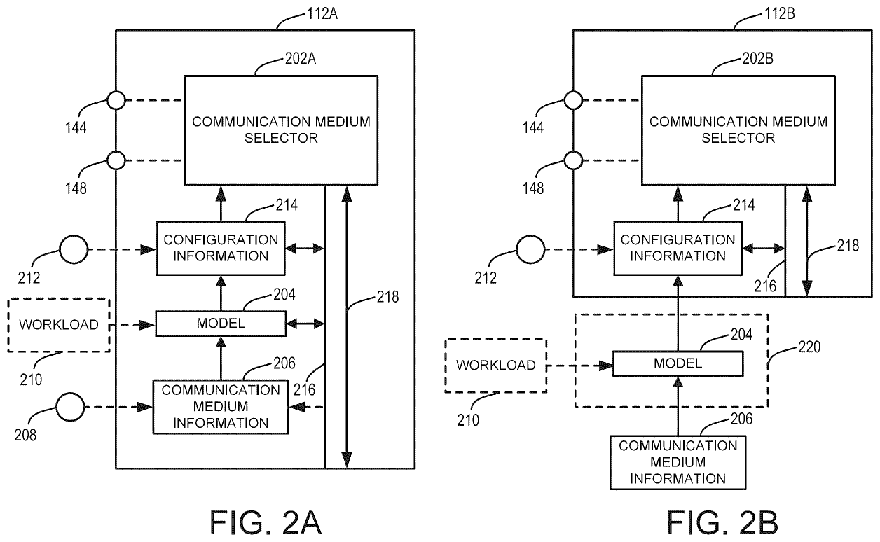

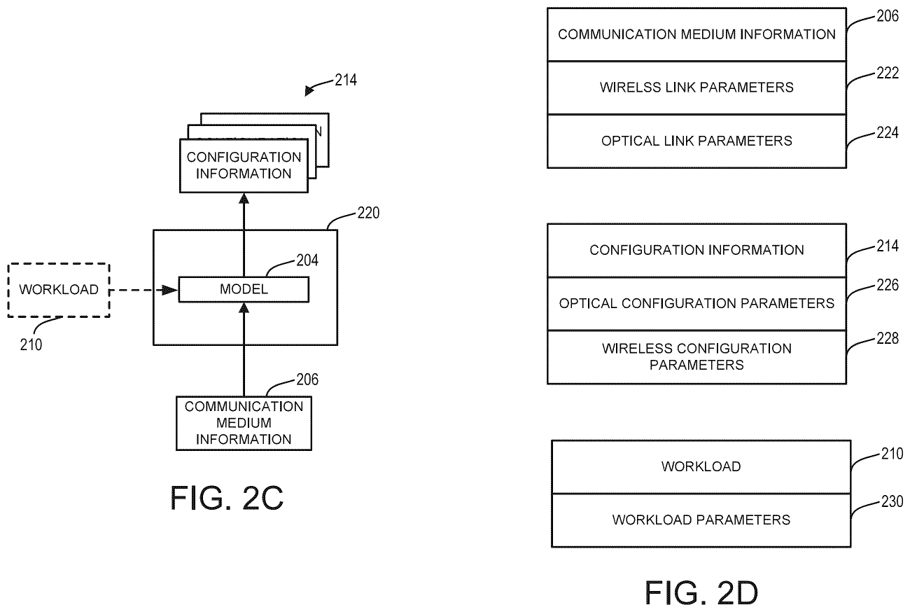

Referring now to FIG. 2A, an example of a controller 112A, is illustrated in accordance with at least one aspect of the present disclosure. The controller 112A may be implemented as part of the controller 112 previously described with respect to FIGS. 1A and 1B. The controller 112A may be configured to select one or more communication interfaces in the hybrid network interface controller 100A and/or 100B as described with respect to FIGS. 1A-1B. Controller 112A may include a communication medium selector 202A in some aspects. The communication medium selector 202A may be configured to control or influence data traffic routing to two or more communication interfaces. The communication medium selector 202A may be implemented using digital logic circuitry, a programmable microcontroller, an ASIC, an FPGA, and/or combinations thereof. In some aspects, the communication medium selector 202A includes decision logic that evaluates input parameters and generates control signals to activate, deactivate, or modify the behavior of the communication interfaces. The communication medium selector 202A may operate on configuration information to determine which communication path to enable for a given data transmission.

In the aspect depicted in FIG. 2A, the communication medium selector 202A may control the selection of one or more of an optical communication path via an optical selector 144 and a wireless communication path via a wireless selector 148. The selector 144 and selector 148 may be implemented using switching circuitry, multiplexers, logical gates, or other routing control mechanisms as previously described with respect to FIGS. 1A-1B. In some aspects, the selector 144 and/or selector 148 may provide a gating function that enables or disables signal transmission through their respective communication paths. When activated by the communication medium selector 202A, the optical selector 144 permits data transfer through the optical interface, allowing communication via an optical communication medium. Similarly, when activated by the communication medium selector 202A, the wireless selector 148 permits data transfer through the wireless interface, enabling communication via a wireless communication medium.

Operation of the communication medium selector 202A may be governed at least in part by configuration information 214. The configuration information 214 may indicate how the communication medium selector 202A should operate (e.g., whether to select the optical communication interface, the wireless communication interface, or both interfaces concurrently (e.g., in a load-balanced or failover mode)). The configuration information 214 may include selection parameters, thresholds, timing constraints, and/or operational modes that dictate which communication interface should be active under various conditions. In some aspects, the configuration information 214 may include interface priority designations, traffic steering rules, and/or bandwidth allocation directives that govern how data is routed between available communication media.

In some aspects, the configuration information 214 may be generated by model 204. The model 204 may comprise logic that includes, but is not limited to, a rule-based engine, finite state machine, statistical estimator, or a machine learning model trained to evaluate communication conditions and/or workload profiles. In some implementations, the model 204 may be a neural network, decision tree, support vector machine, or other machine learning algorithm trained to predict optimal communication interface selections based on observed network conditions, application requirements, and/or system states. The model 204 may incorporate deterministic logic (e.g., threshold-based rules) and/or probabilistic reasoning (e.g., statistical inference) to generate interface selection decisions under varying operational scenarios.

In some aspects, the model 204 may be configured to receive one or more inputs, including workload information 210 and/or communication medium information 206, and generate configuration information 214 in response to receiving such information. In some aspects, the model 204 may analyze patterns or trends in the input data to predict which communication interface will provide optimal performance for a given workload and/or network condition. The model 204 may apply weighting factors to different input parameters based on their relevance to current operational objectives (e.g., maximizing throughput, minimizing latency, reducing power consumption).

The workload information 210 may reflect characteristics of a current application workload, such as, but not limited to, bandwidth demands, latency sensitivity, data type, priority level, or protocol requirements. For example, workload information 210 may indicate that a current data flow requires sustained high bandwidth with moderate latency sensitivity, suggesting a preference for the optical interface. Alternatively, the workload information 210 may indicate a burst transmission pattern with strict latency constraints, potentially favoring the wireless interface. In some aspects, the workload information 210 may include application identifiers, service class indicators, or priority tags that help model 204 determine the relative importance of different performance metrics for a current data transmission.

A workload source may supply the workload information 210. In some aspects, the workload source may refer to an external component, such as an orchestration engine, scheduler, or hypervisor, that communicates with the controller 112A over a control plane interface. The workload source may analyze application requirements, monitor system resources, or track service-level objectives to generate workload characterizations. In some implementations, the workload source may pre-classify traffic flows based on application profiles, assigning priority levels or performance requirements that inform interface selection decisions.

The communication medium information 206 may include operational parameters or telemetry data describing the performance, quality, or status of one or more communication interfaces. For example, the communication medium information 206 may include signal-to-noise ratio (SNR), link latency, throughput, jitter, packet error rate, or energy consumption metrics. These metrics may be measured in real-time or aggregated over various intervals to provide instantaneous and historical perspectives on interface performance. In some aspects, the communication medium information 206 includes link health indicators, congestion notifications, or stability assessments that reflect the current operating conditions of each available communication medium.

The communication medium information 206 may originate from one or more external sources, such as communication medium information source 208 (e.g., an optical transceiver, wireless chipset, or monitoring engine). The communication medium information source 208 may include sensor circuits, counters, timers, or analytical components that measure and report relevant performance metrics. In some implementations, the communication medium information source 208 includes diagnostic logic that detects anomalies, predicts degradation trends, or identifies optimal operating parameters for each communication interface.

In some aspects, the communication medium information 206 may be derived, at least in part, from control plane information 216, such as one or more metrics or policies delivered from a management system or orchestrator. The control plane information 216 may include network-wide status updates, congestion notifications, or global optimization directives influencing interface selection decisions. In some aspects, the control plane information 216 provides contextual data that helps the model 204 interpret local measurements in relation to broader system conditions or objectives. In some implementations, the communication medium information 206 and/or the configuration information 214 may be provided via the control plane information 216.

In some implementations, the configuration information 214 may be received directly from an external source 212 (e.g., a management system or orchestrator), bypassing the model 204 altogether. For example, an orchestration system may provide static or policy-driven configuration commands instructing the communication medium selector 202A to operate in a predefined mode (e.g., “optical only,” “prefer wireless,” or “failover enabled”). This direct configuration path may be utilized in scenarios where centralized control is preferred over local decision-making or where system-wide policies must override interface-specific performance considerations.

In some aspects, the configuration information 214 may be provided to the communication medium selector 202A, optionally via a control plane information path 216. The control plane information path 216 may represent a dedicated communication channel, message queue, register interface, or API through which configuration directives are delivered. The control plane information path 216 may also prove an input to the model 204 or be used to provide the communication medium information 206, depending on implementation.

The communication medium selector 202A may communicate via path 218 with other components of the controller 112A and/or other systems within the hybrid network interface controller. The path 218 may represent one or more data or control buses, internal interconnects, or messaging interfaces used to deliver selection outcomes, receive feedback, or update operational state. In some aspects, path 218 carries control signals that activate or deactivate interface components, adjust transmission parameters, or reconfigure data paths based on the selected communication medium.

Referring now to FIG. 2B, another example of a controller 112B, is depicted in accordance with at least one aspect of the present disclosure. The controller 112B may be configured to manage communication path selection in a hybrid network interface controller using externally sourced configuration logic. The controller 112B may be implemented as a specific configuration of the controller 112 previously described in FIGS. 1A and 1B.

In some aspects, the controller 112B may include a communication medium selector 202B, which may be the same as or similar to the communication medium selector 202A. Similar to FIG. 2A, the selection outputs from the communication medium selector 202B may be provided via an optical selector 144 and a wireless selector 148. Each of the optical selector 144 and wireless selector 148 may be implemented as control signals, switchable routing paths, and/or interface-enabling mechanisms configured to activate and/or deactivate a respective communication medium. When activated, the optical selector 144 enables data transmission through the optical interface; similarly, when activated, the wireless selector 148 enables data transmission through the wireless interface. In some implementations, both selectors may be active simultaneously to support concurrent use of multiple communication paths.

In contrast to the embodiment of FIG. 2A, in which a local model 204 may generate configuration information, aspects of the controller 112B may be configured to receive configuration information 214 from one or more external sources. The configuration information 214 may determine the operating state of the communication medium selector 202B (e.g., whether to select the optical interface, the wireless interface, or the optical interface and the wireless interface). The configuration information 214 may include selection commands, operational parameters, or mode settings that control interface activation and data routing decisions.

The configuration information 214 may be received via a control plane information path 216 and may originate from various sources. The control plane information path 216 may represent a management interface, control channel, or administrative API through which external systems can influence or direct the behavior of the controller 112B. In some aspects, the control plane information path 216 supports bidirectional communication, allowing the controller 112B to report status information or performance metrics back to the configuration sources.

For example, configuration information 214 may be derived from or delivered directly by model 204. The model 204 may reside externally to controller 112B and may be implemented as a decision engine or machine-learning inference model operating on workload or link-layer data. By locating model 204 externally, aspects of the controller 112B may take advantage of a form of centralized decision-making, potentially leveraging more comprehensive system knowledge or computational resources than would be available locally. The external model 204 may incorporate network-wide policy considerations, global resource optimization objectives, or cross-device coordination constraints that are difficult to capture in a device-local decision framework.

The model 204 may generate configuration information 214 based on communication medium information 206 (e.g., telemetry from transceivers or monitoring agents) and/or workload information 210 (e.g., throughput demands, latency requirements). In some implementations, the model 204 may apply analytics or learning algorithms that may be impractical to implement within the controller 112B. This may include ensemble models, deep learning networks, or reinforcement learning approaches that adapt interface selection strategies based on observed outcomes across multiple devices or time periods.

As previously described, the communication medium information 206 may reflect current or historical performance metrics associated with the communication media, including but not limited to signal strength, congestion levels, packet loss, jitter, or link availability. The communication medium information 206 may be sourced from internal monitoring systems or external components and delivered as part of the control plane interface. In some aspects, the communication medium information 206 may include aggregated statistics, trend analysis, or predictive indicators that help anticipate future performance variations or degradation patterns.

As previously described, the workload information 210 may describe application-level or system-level data requirements, including service class, priority level, protocol characteristics, or power constraints. In some implementations, the workload information 210 includes application profiles, traffic patterns, or resource utilization metrics that characterize the current operational context. The workload information 210 may originate from a workload source, which may be an orchestrator, scheduling agent, or system controller external to the controller 112B. The workload source may analyze application requirements, monitor system resources, or enforce service-level agreements to generate appropriate interface selection directives.

In yet another aspect, the model 204 may reside in an external management system and/or orchestrator 220. The management system and/or orchestrator 220 may comprise an orchestrator, software-defined networking (SDN) controller, or administrative policy engine. The management system and/or orchestrator 220 may dictate selection behavior according to global policy, system-wide load balancing, or failover logic. In some implementations, the management system and/or orchestrator 220 provides high-level directives that supplement or override both model-generated recommendations and workload-specific configurations.

In some aspects, the communication medium selector 202B may communicate via path 218 with other components of the controller 112B and/or other systems within the hybrid network interface controller. The path 218 may represent one or more data or control buses, internal interconnects, or messaging interfaces used to deliver selection outcomes, receive feedback, or update operational state. In some aspects, the path 218 carries control signals that activate or deactivate interface components, adjust transmission parameters, or reconfigure data paths based on the selected communication medium.

Referring now to FIG. 2C, an external management system and/or orchestrator 220, is illustrated in accordance with at least one aspect of the present disclosure. The external management system and/or orchestrator 220 may be configured to generate configuration information for controlling communication medium selection in one or more hybrid network interface controllers. In some aspects, the external management system and/or orchestrator 220 may be implemented external to the controller 112 and/or hybrid network interface controller 100A/100B described in previous figures, such as within an orchestrator, control plane manager, network management system, or dedicated configuration engine operating in a distributed network environment.

The external management system and/or orchestrator 220 may include a model 204, which may be the same as or similar to the model 204 described with respect to FIGS. 2A and 2B. The model 204 in the external management system and/or orchestrator 220 may be configured to receive and process multiple input signals and produce one or more instances of configuration information 214. In some aspects, model 204 may be implemented using various forms of decision logic, including but not limited to a rule-based decision engine, policy evaluation framework, finite state machine, statistical analyzer, and/or a machine learning model trained on network conditions and workload patterns as previously described. As previously described, when implemented as a machine learning model, the model 204 may incorporate neural networks, decision trees, reinforcement learning algorithms, or other computational approaches that can recognize patterns in input data and generate optimal configuration directives based on those patterns.

In some aspects, the model 204 may receive communication medium information 206, which may be the same as or similar to the communication medium information 206 described with respect to FIGS. 2A and 2B. The communication medium information 206 may be collected from various sources throughout a network, including from the hybrid network interface controllers themselves, from network switches or routers, from dedicated monitoring probes, or from management systems that aggregate performance metrics across multiple devices. In some aspects, the communication medium information 206 may include not only raw performance metrics but also derived analytics, such as link stability predictions, bandwidth forecasts, or anomaly detection results. These derived analytics may provide contextual information that helps the model 204 make more informed configuration decisions that anticipate future network conditions rather than merely reacting to current states.

The model 204 may also receive workload information 210, which may be the same as or similar to the workload information 210 described with respect to FIGS. 2A and 2B. In the context of the external management system and/or orchestrator 220, the workload information 210 may describe the characteristics or demands of one or more applications, services, or tenants operating within a networked environment. The workload information 210 may include parameters such as latency sensitivity (e.g., real-time vs. bulk transfer requirements), throughput needs (e.g., burst rates, sustained bandwidth), security constraints (e.g., encryption requirements, traffic isolation), or job prioritization information (e.g., mission-critical vs. background tasks). In some aspects, the workload information 210 may be provided by various workload-aware systems, including but not limited to application orchestrators, virtual machine monitors, container management platforms, cloud scheduling agents, or similar systems that have visibility into application requirements and behaviors. Such systems may generate workload profiles that characterize network demands of different application components and allow the model 204 to select a communication medium based on specific workload needs. In some implementations, the workload information 210 may include not only current demand information but also predictive indicators of future workload patterns, enabling proactive configuration adjustments that anticipate changing application behaviors.

Using these inputs (communication medium information 206 and workload information 210), the model 204 may generate one or more sets of configuration information 214, which may be the same as or similar to the configuration information 214 described with respect to FIGS. 2A and 2B. The configuration information 214 may indicate how a downstream communication medium selector (e.g., as described in FIG. 2A or 2B) should operate. For example, the configuration information 214 may indicate whether an optical communication path should be preferred for certain types of traffic, whether wireless interfaces should be used as primary or secondary paths for particular data flows, or whether both media should be activated concurrently to support load balancing or redundancy requirements.

In some aspects, the configuration information 214 includes not only basic selection directives but also additional control metadata such as activation thresholds (e.g., signal quality levels that trigger medium switching), policy priorities (e.g., energy efficiency vs. maximum performance), timing parameters (e.g., hysteresis settings to prevent rapid oscillation between interfaces), or conditions under which a re-evaluation should be triggered (e.g., significant changes in workload characteristics or medium performance). This control metadata may allow the communication medium selector in the hybrid network interface controller to make decisions that consider multiple operational objectives and/or adapt to changing conditions without requiring continuous reconfiguration from the external management system and/or orchestrator 220.

In some aspects, the architecture depicted in FIG. 2C represents a configuration that separates configuration generation logic from the controller itself, allowing global or multi-device coordination of communication policies. Such a separation may provide centralized optimization of network resources across multiple devices, coordination of interface selection decisions to avoid potential radio frequency interference or optical congestion, and/or consistent policy enforcement throughout a network domain. In some implementations, this approach may facilitate network management paradigms that include but are not limited to, intent-based networking, software-defined networking (SDN) orchestration, and/or AI-driven network adaptation that optimizes communication medium selection based on changing and/or current operational conditions and service requirements.

In some aspects, the external management system and/or orchestrator 220 may generate configuration information 214 for multiple hybrid network interface controllers, enabling coordinated decision-making that considers system-wide resource constraints and communication optimization opportunities. The external management system and/or orchestrator 220 may also integrate with broader management frameworks, allowing communication medium selection to be governed by high-level business policies, service-level agreements, or operational priorities established at the organizational level.

Referring now to FIG. 2D, example data structures are illustrated that may be utilized in the communication medium selection framework described in connection with FIG. 2A-2C in accordance with at least one aspect of the present disclosure. FIG. 2D depicts how communication medium information 206, configuration information 214, and workload information 210 may each be represented or implemented as collections of parameters associated with communication paths and/or operational criteria associated with a hybrid network interface controller.

In some aspects, the communication medium information 206 may be the same as or similar to the communication medium information 206 described with respect to FIGS. 2A, 2B, and 2C. The communication medium information 206 represents structured data describing one or more communication interfaces available to a hybrid network interface system. In some aspects, the communication medium information 206 may include a variety of real-time and/or historical telemetry values relevant to interface performance that is collected from or associated with the optical interface 104 and wireless interface 108 described in FIGS. 1A and 1B.

Among other parameters, the communication medium information 206 may include wireless link parameters 222 and optical link parameters 224. The wireless link parameters 222 may include a plurality of measurements or metrics that characterize the performance, status, or quality of a wireless communication link. In some implementations, the wireless link parameters 222 may include, but are not limited to, received signal strength indication (RSSI), which quantifies the power present in a received radio signal; SNR, which measures the ratio of signal power to noise power; wireless latency measurements, which indicate the time delay in milliseconds for packet transmission; jitter metrics, which describe variations in packet delay; link error rate, which quantifies the frequency of transmission errors; and/or channel utilization metrics, which indicate the percentage of available bandwidth currently in use.

The wireless link parameters 222 may be obtained through various measurement techniques, including direct sampling of radio frequency signals, statistical analysis of packet transmission characteristics, or polling of hardware registers within the wireless module 124 described in FIG. 1A. In some aspects, the wireless link parameters 222 may be collected at different time scales, ranging from instantaneous readings to time-averaged values that reflect sustained performance trends. These parameters may be represented in various formats, including raw numerical values, normalized indicators, categorical classifications (e.g., “excellent,” “good,” “fair,” “poor”), or trend indicators that show whether performance is improving, degrading, or stable over time.

The optical link parameters 224 may include a plurality of measurements or metrics that characterize the performance, status, or quality of an optical communication link. In some implementations, the optical link parameters 224 may include, but are not limited to, optical power level, which measures the strength of received or transmitted optical signals in decibels (dBm); forward error correction (FEC) rate, which indicates how frequently error correction mechanisms are being employed to recover from signal degradation; bit error rate (BER), which quantifies the proportion of bits received with errors relative to the total bits transmitted; dispersion metrics, which characterize the spreading of optical pulses during transmission; and/or optical signal-to-noise ratio (OSNR), which measures the ratio of signal power to noise power in the optical domain.

The optical link parameters 224 may be collected through various measurement techniques, including direct optical power measurements, statistical analysis of digital errors post-reception, or monitoring of optical transceiver diagnostic data from the optical module 116 described in FIG. 1A. Similar to the wireless link parameters 222, the optical link parameters 224 may be collected at different time scales and represented in various formats to provide both immediate operational status and long-term performance trends that may inform communication medium selection decisions.

The configuration information 214 may be the same as or similar to the configuration information 214 described with respect to FIGS. 2A, 2B, and 2C. The configuration information 214 may represent decision outputs used to control the behavior of a communication medium selector (e.g., communication medium selector 202A or 202B described in FIGS. 2A and 2B). In some aspects, the configuration information 214 includes the actionable directives that determine how data will be routed through the available communication interfaces of the hybrid network interface controller. As depicted in FIG. 2D, the configuration information 214 may include optical configuration parameters 226 and wireless configuration parameters 228. The optical configuration parameters 226 may define operational settings or selection directives related to the optical interface, such as interface enablement flags (e.g., binary indicators specifying whether the optical interface should be active or inactive), priority level assignments (e.g., numerical or categorical values indicating the preference level for routing certain traffic types through the optical medium), time scheduling instructions (e.g., temporal patterns for interface activation or deactivation), and/or failover conditions (e.g., trigger thresholds that determine when traffic should be moved to an alternative interface). The optical configuration parameters 226 may include quality-of-service mappings that associate different traffic classifications with specific optical transmission behaviors or resource allocations.

Similarly, the wireless configuration parameters 228 may include settings related to wireless interface behavior, such as preferred frequency bands (e.g., channel selection directives), modulation schemes (e.g., instructions regarding signal encoding techniques), antenna control instructions (e.g., beamforming directives), and/or throughput thresholds (e.g., minimum bandwidth requirements that must be satisfied for the wireless interface to be considered viable). The wireless configuration parameters 228 may include power management directives that govern transmit power levels, duty cycling behavior, or energy conservation modes for the wireless interface.

In some implementations, both the optical configuration parameters 226 and the wireless configuration parameters 228 may include selection logic that refers to conditions under which each respective interface should be used exclusively, in a load-sharing arrangement, or in a primary-backup configuration. Such selection logic may be expressed as conditional statements, decision trees, or weighted scoring functions that evaluate current operational conditions against predetermined criteria or learned patterns.

The workload information 210 may be the same as or similar to the workload information 210 described with respect to FIGS. 2A, 2B, and 2C. The workload information 210 may represent characteristics or requirements of the system or application workload, which may influence communication medium selection decisions made by the controller 112 or model 204 as previously described. The workload information 210 may provide context about the nature and demands of the data traffic that will be transmitted, allowing the communication medium selector to align interface selection with specific application needs or system priorities.

The workload information 210 may comprise one or more workload parameters 230. The workload parameters 230 may include, but are not limited to, application type identifiers (e.g., codes or labels that characterize the generating application as video streaming, database transaction, file transfer, etc.), quality-of-service (QoS) level indicators (e.g., priority classifications that reflect the relative importance of the traffic), data rate requirements (e.g., minimum or expected bandwidth needs expressed in bits per second), delay sensitivity metrics (e.g., maximum acceptable latency values), energy constraints (e.g., power budget allocations or battery preservation directives), or user-defined communication policies (e.g., administrative rules or preferences regarding network resource utilization).

In some aspects, the workload parameters 230 may be derived from various sources, including application metadata, tenant service level agreements, system management directives, or dynamic resource allocation algorithms. The workload parameters 230 may be generated by the host system 156 described in FIG. 1A and communicated to the hybrid network interface controller through the coupling interface 132, or they may be assigned by network management systems or orchestration platforms external to the individual computing node.

The data from the data structures illustrated in FIG. 2D may be used individually or in combination with a selection model (e.g., model 204 described in FIGS. 2A, 2B, and 2C) to determine how communication should be routed through the optical and/or wireless interfaces of a hybrid network interface controller. In some aspects, the parameter groups may be encoded in structured formats (e.g., JavaScript Object Notation (JSON), Type-Length-Value (TLV), Protocol Buffers (protobuf)), exchanged between systems over control plane channels, or stored in configuration memory within the controller 112 previously described.

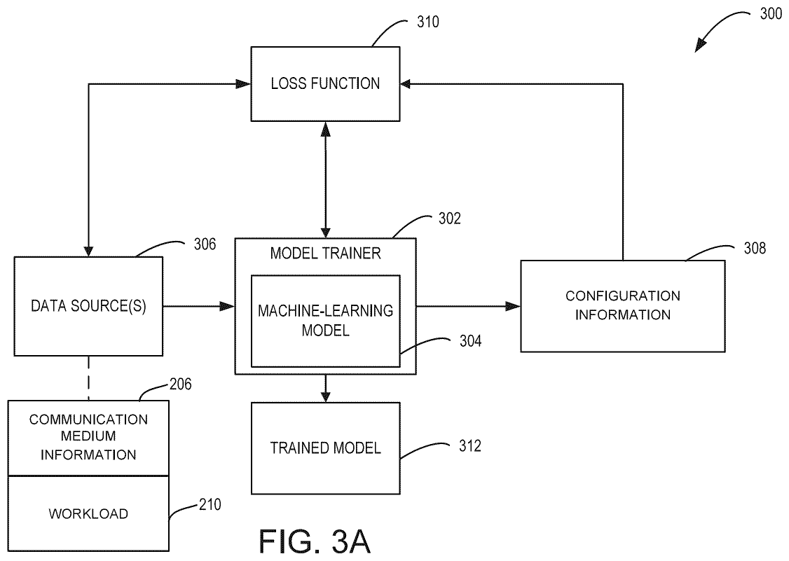

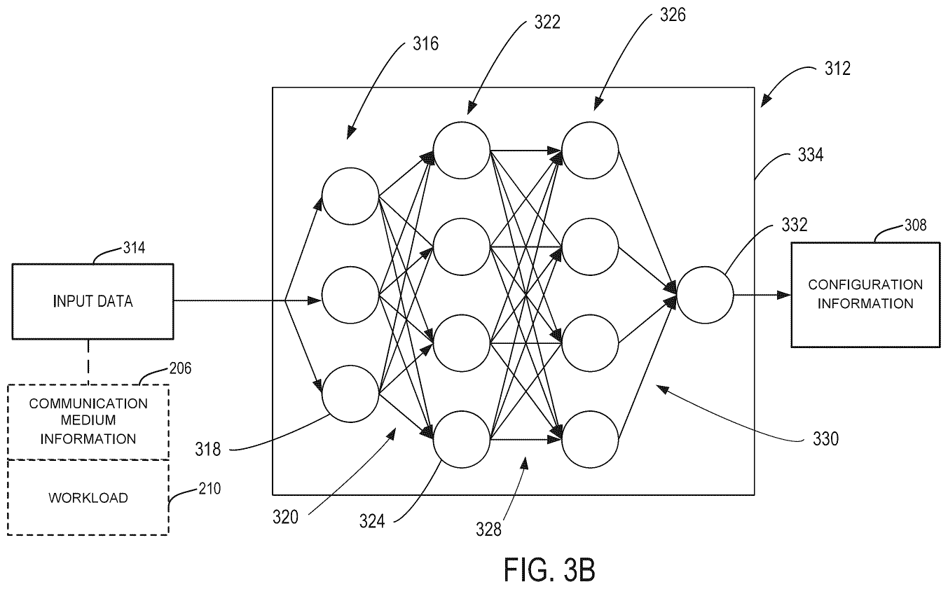

Referring now to FIG. 3A, a training system 300 is illustrated in accordance with at least one aspect of the present disclosure. The training system 300 may be configured to generate a machine-learned model for selecting a communication medium in a hybrid network interface environment. The training system 300 may operate in an offline or online manner. The training system 300 may be implemented in various network infrastructure components, including but not limited to a controller, an orchestration platform, a training node, or within a network management system.

In some aspects, the training system 300 may include a model trainer 302, configured to generate and refine a machine-learning model 304. The machine-learning model 304 may be trained to predict or generate configuration information 308 based on input features. The machine-learning model 304 may comprise a variety of learning architectures suited for processing network performance data and determining appropriate interface selection directives. The machine-learning model 304 may be implemented using one or more computational approaches, including but not limited to a supervised learning model, an unsupervised clustering model, a regression estimator, a neural network, a decision tree, a random forest, a support vector machine, a Bayesian network, a reinforcement learning agent, or other statistical or algorithmic predictor.

In some implementations, the machine-learning model 304 may be a neural network with multiple layers, wherein each layer comprises computational nodes that transform input data through a series of mathematical operations. The neural network may include convolutional layers for feature extraction, recurrent layers for sequence processing, or transformer architectures for capturing temporal relationships in network performance data. In other implementations, the machine-learning model 304 may be a decision tree or ensemble of trees that partitions the input space according to feature thresholds, providing interpretable decision boundaries for interface selection. In yet other implementations, the machine-learning model 304 may employ reinforcement learning techniques that optimize interface selection strategies through interactions with the network environment, learning from the outcomes of previous selection decisions to maximize performance metrics over time.

In some aspects, the model trainer 302 may receive input data from one or more data source(s) 306. The data source(s) 306 may include various information repositories or data streams that provide training examples for the machine-learning model 304. These data sources 306 may include real-time measurements, historical datasets, performance logs, or synthetic training data and may be collected from simulation environments, deployed devices, or external telemetry feeds. The data source(s) 306 may provide labeled examples that associate specific network conditions and workload characteristics with optimal interface selection decisions, enabling supervised learning approaches. In some aspects, the data sources 306 may provide unlabeled data that allows the machine-learning model 304 to discover patterns or clusters in network behavior, supporting unsupervised or semi-supervised learning approaches.

In some aspects, the data source(s) 306 include or are derived from communication medium information 206 and workload information 210, which may be the same as or similar to the communication medium information 206 and workload information 210 described with respect to FIGS. 2A-2D.

In some aspects, the data source(s) 306, communication medium information 206 and workload information 210, may be provided as ground truth data for training the machine-learning model 304. A dataset of the data source(s) 306 may include known relationships between media conditions, workload parameters, and optimal or expected configuration decisions. Such examples may allow the machine-learning model 304 to learn appropriate mappings between inputs and outputs and develop an internal representation of how different network conditions and workload requirements should influence interface selection.

The training system 300 may utilize a loss function 310 to evaluate the performance of the machine-learning model 304 during training. In some aspects, the loss function 310 compares the configuration information 308 output from the machine-learning model 304 to an expected or labeled configuration information (e.g., ground truth in some instances) and generates a quantitative measure of prediction error. The loss function 310 may be implemented using various mathematical formulations depending on the nature of the prediction task and model architecture. For classification tasks, such as determining which interface to activate, the loss function 310 may employ cross-entropy loss or hinge loss. For regression tasks, such as determining bandwidth allocation percentages, the loss function 310 may utilize mean squared error or mean absolute error. For multi-objective optimization scenarios, the loss function 310 may incorporate weighted combinations of multiple metrics that address competing performance goals, such as maximizing throughput while minimizing latency or power consumption.

In some aspects, the loss function 310 generates a score or gradient that quantifies the error or divergence between the model's prediction (e.g., configuration information 308) and ground truth. The error signal provides feedback that guides the optimization process, allowing the model trainer 302 to adjust the internal parameters of the machine-learning model 304 through techniques such as gradient descent, adaptive moment estimation, or other optimization algorithms. The model trainer 302 may use such feedback to update and improve the machine-learning model 304 over multiple iterations or training cycles, reducing prediction error and improving the machine-learning model's ability to make effective interface selection decisions across diverse network scenarios.

Once training is complete or reaches an acceptable performance threshold, the model trainer 302 produces a trained model 312. The trained model 312 represents the optimized version of the machine-learning model 304, with parameters and structural elements configured to perform effective interface selection based on the patterns learned during training. The trained model 312 may include fine-tuned weight matrices, optimized decision boundaries, or learned representations that encode the relationship between network conditions, workload characteristics, and appropriate interface configuration directives.

The trained model 312 may then be deployed to a controller, selector, or external configuration system (e.g., as described with respect to FIGS. 2A-2C) and used to generate real-time configuration information for selecting a communication medium in a hybrid network interface controller. In some implementations, the trained model 312 may be compressed or quantized to reduce computational requirements while maintaining prediction accuracy, enabling an efficient execution on resource-constrained devices. In other implementations, the trained model 312 may be periodically updated or fine-tuned based on new data, allowing the system to adapt to evolving network conditions or workload patterns.

Referring now to FIG. 3B, an example aspect of a trained model 312 is depicted in accordance with at least one aspect of the present disclosure. The trained model 312 may be the same as or similar to the trained model 312 described with respect to FIG. 3A. In the example depicted in FIG. 3B, the trained model 312 is configured as a neural network architecture designed to process input data 314 and generate configuration information 308 for selecting or controlling communication media in a hybrid network interface system.

In some aspects, input data 314 is provided to the neural network 334, where the input data 314 may include or be derived from communication medium information 206 and workload information 210, as described previously in FIG. 2A-2D and 3A. The input data 314 may include various features or parameters that characterize the current state of the network interfaces and workload requirements. Such features may be preprocessed or transformed before being provided to the model, using techniques such as normalization, scaling, one-hot encoding, or feature extraction to enhance the model's learning efficiency and generalization capabilities.

The input data 314 may be received by an input layer 316 of the neural network 334. The input layer 316 may comprise a plurality of input nodes 318, each representing an individual input feature or dimension. For example, individual nodes within the input layer 316 may correspond to parameters from the communication medium information 206 or workload information 210, such as signal strength measurements, error rates, bandwidth requirements, or application types. The input layer 316 acts as the entry point for data into the neural network 334, providing a structured representation of the features that will influence the interface selection decision.

Each input node 318 in the input layer 316 may be connected to a set of hidden layer nodes 322 via a set of weighted input-to-hidden layer connections 320. The weighted input-to-hidden layer connections 320 represent the learned associations between input features and intermediate representations within the neural network 334. Each connection may be assigned a weight value that determines the strength of the signal passed from an input node to a hidden node. In some aspects, weights are tuned during the training process described in FIG. 3A, with the model adjusting connection strengths to minimize prediction error. The pattern of connections and their associated weights encodes the model's understanding of how different input features should influence the activation of nodes in the subsequent layer.

The neural network 334 includes one or more hidden layers, such as the layer comprising hidden node 322, which may generate intermediate representations of the input data. The hidden nodes 322 may process their inputs, combining signals from multiple input nodes according to the connection weights and then applying a non-linear activation function to introduce complexity into the model's computational capabilities. Common activation functions include rectified linear units (ReLU), sigmoid functions, hyperbolic tangent (tanh), or leaky ReLU variants, each offering different properties regarding gradient propagation and feature representation. The hidden nodes 322 collectively form a distributed representation that captures patterns, correlations, or abstractions within the input data relevant to the interface selection task.

In some aspects, a subsequent hidden layer comprising hidden layer 326 and associated hidden nodes 324 may be included in the neural network 334. The hidden nodes 324 within hidden layer 326 receive input from the preceding layer's hidden node 322, allowing the model to build increasingly abstract or complex representations of the input data. By stacking multiple hidden layers, the neural network can learn hierarchical features, with earlier layers typically detecting basic patterns (e.g., simple correlations between signal strength and error rates) and deeper layers combining these basic patterns into more sophisticated concepts (e.g., complex relationship patterns that indicate when wireless communication might be preferable despite lower signal strength due to specific workload characteristics).

The hidden nodes 322 of the first hidden layer are connected to the hidden nodes 324 of the second hidden layer 326 via a set of hidden-to-hidden layer connections 328. The hidden-to-hidden layer connections 328 propagate activations through the network while enabling the model to learn hierarchical or compositional features relevant to communication behavior. Similar to the input-to-hidden layer connections 320, these connections are assigned weights during training that determine how strongly each node in the first hidden layer influences the activation of nodes in the second hidden layer. The pattern of connections between hidden layers allows the model to compose increasingly complex feature representations as information flows through the network.

The final hidden layer 326 output is provided to an output layer comprising one or more output nodes 332. These output nodes 332 are connected to the last hidden layer via a set of hidden-to-output layer connections 330. The output nodes 332 are configured to produce one or more outputs representing configuration information 214. This configuration information 214 may include directives to activate a particular communication medium (e.g., optical or wireless), apply a specific routing rule, or adjust transmission behavior. Depending on the specific requirements of the interface selection task, the output layer may be structured in various ways. For classification decisions, such as selecting between optical, wireless, or dual-interface operation, the output node 332 may produce probability distributions or discrete class assignments. For parameter tuning tasks, such as determining bandwidth allocation ratios or transmission power levels, the output node 332 may generate continuous values within appropriate ranges.

In some embodiments, the trained model 312 may be implemented as part of a runtime decision engine (e.g., in FIG. 2A-2C) or as a trained model (e.g., 312 in FIG. 3A) deployed into a control plane or network interface component. When deployed, the trained model 312 may process current network conditions and workload characteristics in real-time, generating configuration directives that optimize interface selection based on learned patterns and relationships.

The neural network architecture depicted in FIG. 3B represents one possible implementation of the machine-learning model 304. Alternative architectures may be employed depending on specific requirements or constraints. For example, recurrent neural networks or long short-term memory (LSTM) networks may be used when temporal patterns in network performance are significant. Convolutional architectures might be applied when spatial or structural relationships exist in the input data. Graph neural networks could be used to model complex dependencies between network elements or communication pathways. The specific architecture may be selected based on factors such as the nature of the available data, the complexity of the decision space, computational resource constraints, or interpretability requirements.

Various regularization techniques may be applied to the trained model 312 to improve generalization performance and prevent overfitting to training data. These techniques may include dropout (randomly deactivating nodes during training), weight decay (penalizing large weight values), batch normalization (normalizing activations between layers), or early stopping (terminating training when validation performance begins to degrade).

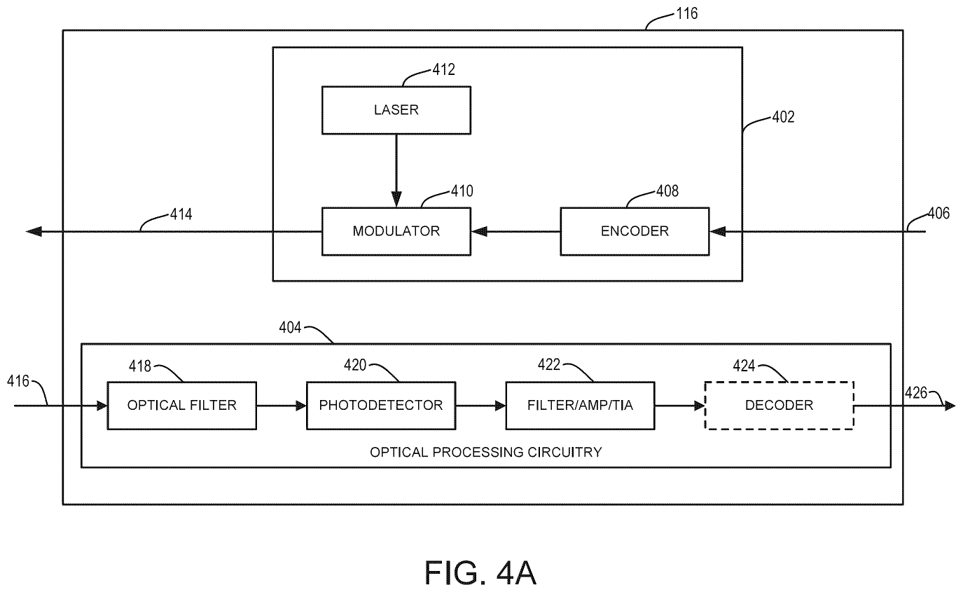

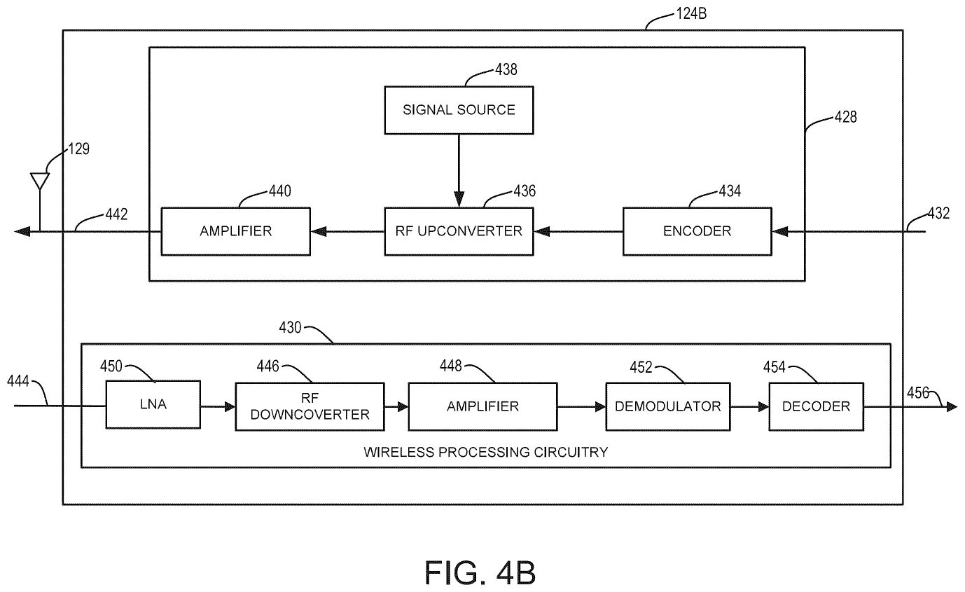

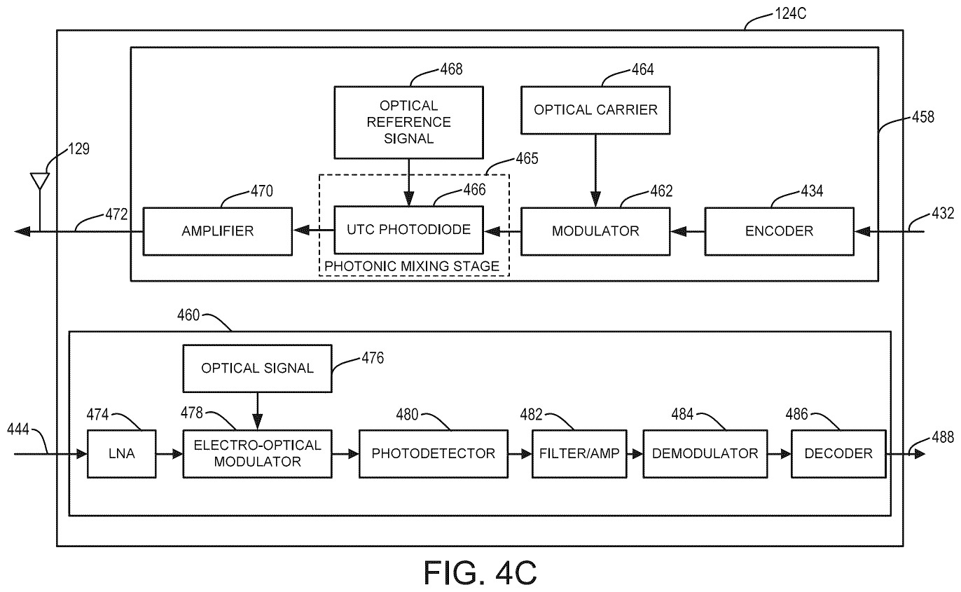

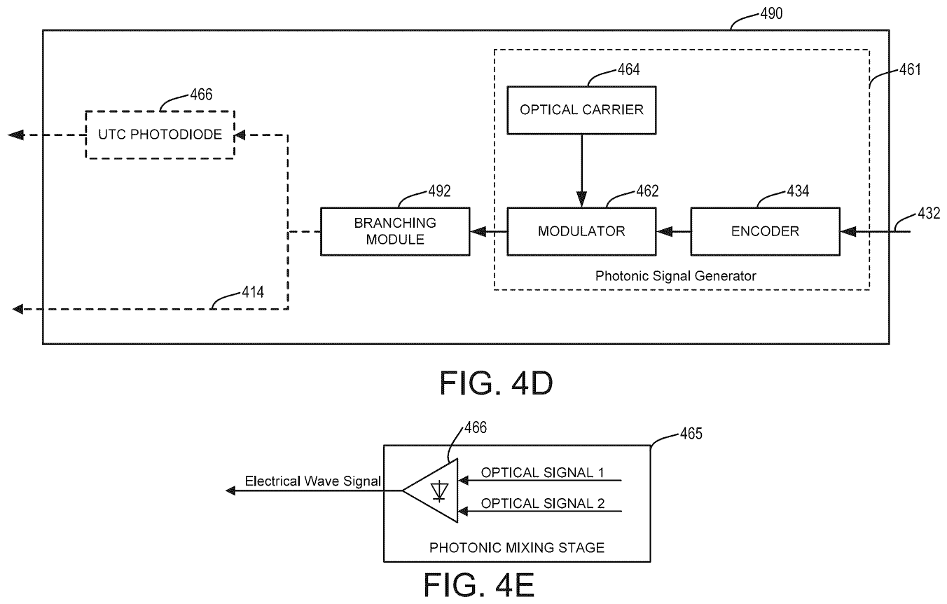

Referring now to FIG. 4A, an optical module 116 is depicted in accordance with at least one aspect of the present disclosure. The optical module 116 may be incorporated as a component of the hybrid network interface controller described in previous figures, such as the optical interface 104 of FIGS. 1A and 1B. The optical module 116 may provide bidirectional optical communication capabilities through a transmit path 402 and a receive path 404, enabling the hybrid network interface controller to communicate via optical communication media.

In some aspects, the optical module 116 may be implemented using various form factors and integration approaches, including but not limited to a pluggable transceiver module, an integrated photonic circuit, or a discrete optoelectronic assembly mounted to a printed circuit board within the network interface controller. The optical module 116 may support various optical transmission standards, protocols, and data rates suitable for data center, enterprise, or high-performance computing environments.

In some aspects, the transmit path 402 may include a series of components configured to convert electrical signals into modulated optical signals suitable for transmission over an optical communication medium. The transmit path 402 may receive an electrical input signal 406, which may originate from a MAC circuit, controller, or host interface within the hybrid network interface controller. The electrical input signal 406 may represent serialized data from higher protocol layers prepared for physical layer transmission.

The electrical input signal 406 may be provided to an encoder 408, which performs signal encoding operations to prepare the electrical data for optical transmission. In some aspects, the encoder 408 may implement various encoding schemes, such as non-return-to-zero (NRZ), pulse-amplitude modulation (PAM), or more advanced modulation formats. The encoder 408 may perform line coding functions such as 8b/10b encoding, 64b/66b encoding, or other data conversion techniques that ensure DC balance, clock recovery capability, and error detection. In some implementations, the encoder 408 may incorporate FEC coding to enhance transmission reliability over the optical medium. The encoder 408 may be implemented using dedicated digital signal processing (DSP) circuitry, an ASIC, a field-programmable gate array (FPGA), or other suitable digital logic.

The encoded electrical signal from the encoder 408 may be provided to a modulator 410, which converts the electrical signal into corresponding optical signal variations. The modulator 410 receives a continuous-wave optical signal from a laser 412 and modulates the carrier signal according to the encoded electrical data. In some aspects, the modulator 410 may employ various modulation techniques, including but not limited to direct modulation of the laser current and external modulation using electro-optic modulators such as Mach-Zehnder interferometers or electroabsorption modulators. The modulation scheme may be selected based on factors such as data rate, transmission distance, power consumption requirements, or integration constraints.

In some aspects, the laser 412 generates the continuous-wave optical carrier signal used for data transmission. The laser 412 may be implemented using various semiconductor laser technologies, including but not limited to distributed feedback (DFB) lasers, vertical-cavity surface-emitting lasers (VCSELs), or other coherent light sources suitable for optical fiber transmission. In some aspects, the laser 412 may operate at specific wavelengths compatible with industry-standard optical communication windows, such as 850 nm for multi-mode transmission or 1310/1550 nm for single-mode applications. The laser 412 may include stabilization circuitry to maintain wavelength accuracy, power control mechanisms to ensure appropriate optical output levels, and monitoring capabilities to ensure proper operation.

The modulated optical signal generated by the interaction of the modulator 410 with the laser 412 output is directed to an optical output 414. The optical output 414 may include optical coupling elements such as lenses, waveguides, or fiber alignment structures that transfer the modulated light into an external optical fiber or waveguide. In some implementations, the optical output 414 may include optical isolation components to prevent back-reflections from disrupting the laser operation or include monitoring taps that sample a portion of the output power for diagnostic purposes.

In some aspects, the receive path 404 includes a series of components (e.g., optical processing circuitry) configured to convert incoming optical signals into electrical signals that the hybrid network interface controller can process. The receive path 404 may accept an incoming optical signal at optical input 416, which may include optical coupling elements similar to those described for the optical output 414 but configured to capture light from an external optical fiber and direct it into the internal optical components of the receive path. The incoming optical signal from the optical input 416 is directed to an optical filter 418. The optical filter 418 may perform wavelength selection or noise filtering functions to improve the signal quality before detection. In some aspects, the optical filter 418 may be a thin-film filter, fiber Bragg grating, or other wavelength-selective element that passes the desired signal wavelength while attenuating out-of-band noise or adjacent channel interference in wavelength-division multiplexed systems. The optical filter 418 may enhance receiver sensitivity by improving the optical signal-to-noise ratio of the incoming signal.

The filtered optical signal is then directed to a photodetector 420, which converts the optical signal into a corresponding electrical current or voltage. The photodetector 420 may be implemented using various optoelectronic technologies, including but not limited to positive-intrinsic-negative (PIN) photodiodes, avalanche photodiodes (APDs), or integrated photodetectors within photonic integrated circuits. The selection of photodetector technology may depend on factors such as required sensitivity, bandwidth, noise characteristics, or cost constraints. In some implementations, the photodetector 420 may include integrated transimpedance amplification to convert the photo-generated current into a voltage signal.

The electrical signal produced by the photodetector 420 may be provided to a filter/amplifier/transimpedance amplifier (TIA) stage 422. This stage may perform multiple signal conditioning functions to prepare the detected signal for subsequent digital processing. In some aspects, the filter/amplifier/TIA stage 422 may include transimpedance amplification to convert photodetector current into voltage with appropriate gain, equalization filtering to compensate for channel impairments or enhance signal bandwidth, automatic gain control to maintain consistent signal levels despite variations in optical input power, and/or noise filtering to improve signal quality. The filter/amplifier/TIA stage 422 may be implemented using discrete analog components, integrated analog circuits, or mixed-signal devices that combine analog processing with digital control capabilities.

In some implementations, the filter/amplifier/TIA stage 422 signal may be further processed by an optional decoder 424, shown in dashed lines to indicate its optional nature in some aspects. When present, the decoder 424 may perform functions such as clock and data recovery to extract timing information from the received signal, line decoding to reverse the encoding applied at the transmitter (e.g., 8b/10b decoding), and error detection or correction using forward error correction codes. The decoder 424 may be implemented using dedicated digital signal processing circuitry, an ASIC, an FPGA, or other suitable digital logic.

The processed electrical signal from the receive path 404 may be provided as an output 426. The output 426 may be provided to one or more subsequent stages in the hybrid network interface controller, such as a MAC circuit, controller, or host interface, delivering the recovered data for higher-layer protocol processing or forwarding to the host system.

FIG. 4A illustrates one possible implementation of an optical module architecture that provides bidirectional conversion between electrical and optical domains. However, it should be understood that this is merely exemplary, and the present disclosure contemplates various alternative implementations of the optical module. Such alternative implementations may include different component arrangements, additional or fewer components, alternative technologies for signal generation and detection, or variations in the signal processing chain. The specific implementation may be selected based on factors such as cost considerations, performance requirements, size constraints, power limitations, or integration with other system components while maintaining compatibility with the overall hybrid interface architecture.

Referring now to FIG. 4B, an exemplary aspect of a wireless module 124B, is illustrated in accordance with at least one aspect of the present disclosure. The wireless module 124B may be incorporated as a component of the hybrid network interface controller described in previous figures, such as the wireless interface 108 of FIGS. 1A and 1B. The wireless module 124B may provide bidirectional wireless communication capabilities through a transmit path 428 and a receive path 430, enabling the hybrid network interface controller to communicate via wireless communication media.

In some aspects, the wireless module 124B may be implemented using various form factors and integration approaches, including but not limited to a radio frequency integrated circuit (RFIC), a system-on-chip (SoC) with integrated RF components, or an assembly of discrete RF components mounted to a printed circuit board within the network interface controller. The wireless module 124B may support various wireless transmission standards, protocols, and data rates suitable for data center, enterprise, or high-performance computing environments.

The transmit path 428 comprises a series of components configured to generate and transmit RF signals based on electrical input data. The transmit path 428 receives an electrical input signal as input 432, which may originate from a MAC circuit, controller, or host interface within the hybrid network interface controller. The electrical input signal may represent serialized data from higher protocol layers prepared for physical layer transmission.

The electrical input (e.g., input 432) may be provided to an encoder 434, which performs signal encoding operations to prepare the electrical data for wireless transmission. In some aspects, the encoder 434 may implement various encoding schemes such as Binary Phase Shift Keying (BPSK), Quadrature Phase Shift Keying (QPSK), Quadrature Amplitude Modulation (QAM), or more advanced modulation formats like Orthogonal Frequency Division Multiplexing (OFDM). The encoder 434 may perform functions such as FEC, interleaving, framing, or other data conversion techniques that enhance transmission reliability over wireless media. In some implementations, the encoder 434 may incorporate protocol-specific framing for standards such as IEEE 802.11 (Wi-Fi), 5G NR, or proprietary protocols. The encoder 434 may be implemented using dedicated DSP circuitry, an ASIC, FPGA, or other suitable digital logic.

The encoded signal from the encoder 434 may then be delivered to an RF upconverter 436. The RF upconverter 436 may shift the baseband or intermediate-frequency (IF) signal to a higher carrier frequency suitable for wireless transmission. In some aspects, the RF upconverter 436 may include one or more mixing stages, filter elements, and impedance-matching networks to ensure proper signal translation to the desired radio frequency band. The RF upconverter 436 may operate in various frequency bands, including but not limited to sub-6 GHz, millimeter-wave (e.g., 24-100 GHz), or terahertz frequencies, depending on the specific implementation and application requirements.

The RF upconverter 436 may receive a frequency reference from signal source 438. The signal source 438 may comprise a local oscillator, phase-locked loop (PLL), clock generator, and/or frequency synthesizer that provides the carrier frequency for upconversion operations. In some aspects, the signal source 438 may be tunable to support multiple frequency channels or bands. The signal source 438 may include frequency stabilization circuitry to maintain accurate carrier frequency generation, phase noise reduction components to enhance signal quality, and calibration mechanisms to ensure compliance with regulatory requirements or protocol specifications.

The upconverted RF signal from the RF upconverter 436 is provided to an amplifier 440. The amplifier 440 increases the power level of the RF signal to ensure sufficient transmission strength. In some aspects, the amplifier 440 may include one or more amplification stages, such as a driver amplifier followed by a power amplifier (PA), to achieve a required transmission power while maintaining signal linearity and efficiency. The amplifier 440 may incorporate power control mechanisms to adjust output levels based on transmission distance, link quality requirements, or energy conservation directives from the controller. In some implementations, the amplifier 440 may include linearization techniques such as digital predistortion or envelope tracking to enhance efficiency at higher power levels.

The amplified RF signal from the amplifier 440 is then directed an a wireless output 442. The wireless output 442 may be further provided to impedance-matching networks, filters, and/or transmission line structures that transfer the RF energy to an external antenna (e.g., antenna 129) or transmission structure. In some aspects, the wireless output 442 may be provided to one or more diagnostic capabilities to monitor forward and reflected power levels for link quality assessment or protection functions.

In some aspects, the receive path 430 comprises components (e.g., wireless processing circuitry) configured to receive incoming RF signals and convert them into baseband digital data suitable for processing by the hybrid network interface controller. The receive path 430 may accept an incoming wireless signal as input 444. The input 444 may be routed to/from one or more RF coupling elements, impedance matching structures, or filtering components configured to efficiently capture RF signals from an external antenna and direct them into the internal components of the receive path.

The incoming RF signal received from the input 444 is then directed to an LNA 450. The LNA 450 may amplify a weak received RF signal while introducing minimal additional noise. The LNA 450 may incorporate automatic gain control mechanisms to accommodate varying input signal strengths while preventing saturation of subsequent stages. In some implementations, the LNA 450 may include multiple gain stages with one or more filtering stages to provide amplification and selectivity.

The amplified RF signal from the LNA 450 may be directed to the RF downconverter 446. The RF downconverter 446 may shift the received signal from its RF carrier frequency to an intermediate frequency or directly to the baseband for subsequent processing. In some aspects, the RF downconverter 446 may include mixing stages, filter elements, and gain control mechanisms to ensure proper signal translation while maintaining signal quality. The RF downconverter 446 may utilize the same or a separate frequency reference as the transmit path to ensure coherent demodulation.

The down-converted signal from the RF downconverter 446 may be provided to an amplifier 448. The amplifier 448 increases the signal level of the down-converted signal to ensure detection and processing. In some aspects, the amplifier 448 may include a low-noise amplifier (LNA) to enhance sensitivity while minimizing noise contribution, automatic gain control (AGC) circuitry to accommodate varying input signal strengths, or variable gain stages to optimize signal levels for subsequent processing. The amplifier 448 may be implemented using various RF amplification technologies selected based on noise figure, linearity, power consumption, or integration requirements.

The amplified signal from the amplifier 448 is then directed to a demodulator 452. The demodulator 452 may extract the baseband data signal from the modulated waveform according to the modulation scheme used by the transmitter. In some aspects, the demodulator 452 may perform phase recovery, symbol timing recovery, equalization, or other signal processing functions to compensate for channel impairments and improve detection accuracy. The demodulator 452 may be implemented using analog circuitry, digital signal processing techniques, or a combination of both, depending on the specific requirements and constraints of the wireless module 124B.

The demodulated signal from the demodulator 452 is provided to a decoder 454. The decoder 454 processes the demodulated signal to recover the digital data stream originally encoded at the transmitter. In some aspects, the decoder 454 may perform error correction using forward error correction codes, deinterleaving to reverse the interleaving applied at the transmitter, frame alignment to identify packet boundaries, or protocol-specific processing to extract payload data. The decoder 454 may be implemented using dedicated digital signal processing circuitry, an ASIC, an FPGA, or other suitable digital logic.

The output of the decoder 454 is provided as an output 456. The output 456 may be provided to one or more subsequent stages in the hybrid network interface controller, such as a MAC circuit, controller, or host interface, delivering the recovered data for higher-layer protocol processing or forwarding to the host system.

The wireless module 124B may support one or more wireless communication standards, including but not limited to IEEE 802.11 (Wi-Fi), 5G NR, millimeter-wave wireless, or proprietary high-frequency protocols suitable for data center or enterprise applications. In some implementations, the wireless module 124B may be reconfigurable to adapt to different protocols, frequency bands, or operational modes based on controller directives or system requirements.

FIG. 4B illustrates one possible implementation of a wireless module architecture that provides bidirectional wireless communication capabilities. However, it should be understood that this is merely exemplary, and the present disclosure contemplates various alternative implementations of the wireless module. Such alternative implementations may include different component arrangements, additional or fewer components, alternative radio frequency technologies, different frequency bands, or variations in the signal processing chain. The specific implementation may be selected based on factors such as performance targets, integration approaches, cost considerations, or power efficiency requirements while maintaining compatibility with the overall hybrid interface architecture.

Referring now to FIG. 4C, another wireless module 124C is depicted in accordance with at least one aspect of the present disclosure. The wireless module 124C depicted in FIG. 4C represents an example implementation configured to utilize photonic techniques for high-frequency wireless signal generation and processing. The photonic-based approach may be incorporated as a component of the hybrid network interface controller described in previous figures, such as the wireless interface 108 of FIGS. 1A and 1B. The wireless module 124C may provide bidirectional wireless communication capabilities through a wireless transmit path 458 and a wireless receive path 460, each employing optoelectronic components to perform high-frequency signal generation and down-conversion.

The wireless module 124C may be implemented using various integration approaches, including but not limited to integrated photonic circuits, hybrid photonic-electronic assemblies, silicon photonics platforms, or discrete optoelectronic components mounted on a printed circuit board within the network interface controller. In some aspects, the photonic mixing architecture depicted in FIG. 4C may be beneficial for systems needing wide bandwidth operations and/or high-frequency carrier generations with low phase noise. The wireless module 124C may support various wireless transmission standards and protocols suitable for high-speed data transmission in data center, enterprise, or high-performance computing environments, with particular applicability to millimeter-wave and terahertz frequency bands where traditional electronic approaches may face technical limitations.

In the wireless transmit path 458, an electrical input signal may be provided as input 432, which may be associated with digital data from a MAC circuit, controller, or host interface within the hybrid network interface controller. The input 432 may be directed to suitable impedance matching, level shifting, or buffering circuitry to ensure proper signal integrity when transferring data from digital processing circuits to the photonic transmit path components.

The electrical input signal (e.g., input 432) may be provided to an encoder 434, which performs signal encoding operations to prepare the electrical data for wireless transmission. The encoder 434 may implement various encoding schemes such as BPSK, QPSK, QAM, or other modulation formats suitable for high-speed wireless transmission. In some aspects, the encoder 434 may perform functions such as FEC, interleaving, framing, or other data conversion techniques that enhance transmission reliability over wireless media. The encoder 434 may be implemented using dedicated DSP circuitry, an ASIC, an FPGA, or other suitable digital logic.

The encoded signal from the encoder 434 is provided to a modulator 462, which modulates an optical carrier 464 based on the encoded data. The modulator 462 may comprise an electro-optic modulator such as a Mach-Zehnder modulator, electroabsorption modulator, or other device capable of imposing the encoded data onto an optical carrier. In some aspects, the modulator 462 may employ direct modulation techniques, where the drive current of a laser is directly modulated according to the data signal, or external modulation, where an external device modulates a continuous-wave optical signal. The modulator 462 may support various modulation formats, including intensity modulation, phase modulation, or complex modulation schemes that encode multiple bits per symbol to enhance spectral efficiency.

The optical carrier 464 provides a continuous-wave laser signal suitable for photonic up-conversion. The optical carrier 464 may be generated by a laser source such as a DFB laser, external cavity laser, or tunable laser that produces a spectrally pure optical tone. In some implementations, the optical carrier 464 may operate at specific wavelengths compatible with photonic integrated circuit platforms, such as 1310 nm or 1550 nm, which offer low propagation losses in optical waveguides and fibers. The optical carrier 464 may include stabilization circuitry to maintain wavelength accuracy, power control mechanisms to ensure appropriate optical output levels, and monitoring capabilities to ensure proper operation.

The modulated optical signal from the modulator 462 may be directed to a photonic mixing stage 465 which may include a UTC photodiode 466. The UTC photodiode 466 may be a high-speed photodetector optimized for high-frequency applications, and including a structure where electrons travel across the depletion region, resulting in higher bandwidth capabilities compared to conventional PIN photodiodes. The UTC photodiode 466 performs photonic mixing of the modulated carrier and an optical reference signal 468 to generate a high-frequency electrical RF signal. This photonic mixing process leverages optical heterodyning, where the beating of two optical frequencies with a controlled frequency difference generates an electrical signal at their difference frequency. Such a signal may be generated in the millimeter-wave or terahertz range.

The optical reference signal 468 may provide a second optical tone that produces the desired RF carrier frequency when mixed with the modulated optical carrier in the UTC photodiode 466. The optical reference signal 468 may be generated by a separate laser source, derived from an optical frequency comb generator, or created using an optical synthesizer that provides frequency control. The frequency difference between the optical carrier 464 and the optical reference signal 468 may determine the carrier frequency of the generated RF signal. In some implementations, one or both optical signals may be wavelength-tunable to allow adjustable carrier frequency generation, providing flexibility in wireless channel selection or multi-band operation.

The RF signal generated by the UTC photodiode 466 is provided to an amplifier 470, which increases the signal power to a level suitable for wireless transmission. The amplifier 470 may comprise one or more RF amplification stages, such as a pre-amplifier followed by a power amplifier, to achieve the required transmission power while maintaining signal linearity and efficiency. In some aspects, the amplifier 470 may incorporate technologies such as gallium nitride (GaN) or silicon-germanium (SiGe) to provide efficient amplification at millimeter-wave or sub-terahertz frequencies. The amplifier 470 may include power control mechanisms to adjust output levels based on transmission distance requirements, link quality objectives, or energy conservation directives from the controller.

The amplified RF signal from the amplifier 470 is provided as a wireless output 472. The wireless output 472 may be provided to one or more impedance-matching networks, filters, and/or transmission line structures that efficiently transfer the RF energy to an external antenna (e.g., antenna 129), waveguide, or other radiating structure. In some aspects, the wireless output 472 may be provided to one or more coupling elements optimized for millimeter-wave or terahertz frequencies, such as waveguide transitions, probe feeds, or specialized RF connectors that maintain signal integrity at high frequencies. The wireless output 472 may incorporate diagnostic capabilities to monitor forward and reflected power levels for link quality assessment or protection functions.

The wireless receive path 460 is configured to perform photonic down-conversion of received RF signals using electro-optical modulation techniques. An incoming RF signal is received as input 444, which may be routed to/from RF coupling elements, impedance matching structures, or filtering components configured to efficiently capture RF signals from an external antenna and direct them into the internal components of the receive path. The input 444 be routed from/to one or more pre-filtering to reject out-of-band interference or image frequencies that could degrade receiver performance.

The RF signal received from the input 444 may be provided to an LNA 474. The LNA 474 amplifies a weak received RF signal while introducing minimal additional noise. In some aspects, the LNA 474 may be implemented using semiconductor technologies optimized for low-noise performance at high frequencies, such as indium phosphide (InP), gallium arsenide (GaAs), or SiGe processes. The LNA 474 may incorporate automatic gain control mechanisms to accommodate varying input signal strengths while preventing saturation of subsequent stages. In some implementations, the LNA 474 may include multiple gain stages with one or more filtering stages to provide amplification and selectivity.

The amplified RF signal from the LNA 474 is applied to an electro-optical modulator 478, which is also supplied with an optical signal 476. The electro-optical modulator 478 converts the RF signal into optical domain modulation, effectively encoding the RF information onto an optical carrier. This technique leverages the high bandwidth capabilities of optical components to process high-frequency RF. Depending on bandwidth, insertion loss, or integration requirements, the electro-optical modulator 478 may be implemented using various technologies such as lithium niobate modulators, silicon photonics modulators, or polymer-based electro-optic devices.

The optical signal 476 provides a continuous-wave laser signal that serves as the carrier for the electro-optical modulation process. The optical signal 476 may be generated by a laser source similar to those described for the optical carrier 464, selected for spectral purity, stability, and compatibility with the electro-optical modulator 478. In some implementations, the optical signal 476 may be derived from the same laser source used in the transmit path to enhance system coherence or reduce component count.

The modulated optical signal from the electro-optical modulator 478 is directed to a photodetector 480, which converts the optical modulation back into an electrical signal. The photodetector 480 may be implemented using various optoelectronic technologies such as PIN photodiodes, avalanche photodiodes, or specialized high-speed photodetectors optimized for the modulation format and frequency range employed. The photodetector 480 effectively completes the photonic down-conversion process, producing an electrical signal that contains the information from the original RF wireless signal but shifted to a lower frequency range that is more amenable to processing by conventional electronics.

The electrical output from the photodetector 480 is provided to a filter/amplifier stage 482. The filter/amplifier stage 482 performs signal conditioning functions to prepare the detected signal for subsequent processing. In some aspects, the filter/amplifier stage 482 may include transimpedance amplification to convert photodetector current into voltage with appropriate gain, equalization filtering to compensate for channel impairments or enhance signal bandwidth, automatic gain control to maintain consistent signal levels, and noise filtering to improve signal quality. The filter/amplifier stage 482 may be implemented using discrete analog components, integrated analog circuits, or mixed-signal devices that combine analog processing with digital control capabilities.

The conditioned signal from the filter/amplifier stage 482 is provided to a demodulator 484. The demodulator 484 extracts the underlying baseband or intermediate frequency (IF) signal from the received waveform according to the modulation scheme employed by the transmitter. In some aspects, the demodulator 484 may perform phase recovery, symbol timing recovery, equalization, or other signal processing functions to compensate for channel impairments and improve detection accuracy. The demodulator 484 may be implemented using analog circuitry, digital signal processing techniques, or a combination of both, depending on the specific requirements and constraints of the wireless module 124.

The demodulated signal from the demodulator 484 is provided to a decoder 486. The decoder 486 processes the demodulated signal to recover the digital data stream that was originally encoded at the transmitter. In some aspects, the decoder 486 may perform error correction using forward error correction codes, deinterleaving to reverse the interleaving applied at the transmitter, frame alignment to identify packet boundaries, or protocol-specific processing to extract payload data. The decoder 486 may be implemented using dedicated digital signal processing circuitry, an ASIC, an FPGA, or other suitable digital logic.

The decoded digital signal from the decoder 486 is provided as output 488. The output 488 may be provided to one or more subsequent stages in the hybrid network interface controller, such as a MAC circuit, controller, or host interface, delivering the recovered data for higher-layer protocol processing or forwarding to the host system. The photonic-based wireless module 124 depicted in FIG. 4C may enable ultra-wideband and high-frequency wireless communication with potential advantages in spectral purity, frequency stability, and bandwidth compared to conventional all-electronic approaches. Optical carriers and modulators provide high-frequency tunability and integration with other optical components within the hybrid network interface controller.

The photonic-based wireless module 124 illustrated in FIG. 4C represents one possible implementation that enables ultra-wideband and high-frequency wireless communication. However, it should be understood that this is merely exemplary, and the present disclosure contemplates various alternative implementations of photonic-based wireless modules. Such alternative implementations may include different component arrangements, additional or fewer components, alternative photonic mixing technologies, different modulation schemes, or variations in the optical-to-electrical conversion approach. The specific implementation may be selected based on factors such as frequency requirements, bandwidth needs, power constraints, or integration considerations while maintaining the ability to leverage the advantages of photonic signal generation for wireless communication within the hybrid network interface architecture.

Referring now to FIG. 4D, a hybrid optical transmission system 490 is depicted in accordance with at least one aspect of the present disclosure. The hybrid optical transmission system 490 may be configured to generate and selectively route a modulated optical signal for use in either conventional optical communication or photonic RF signal generation. The hybrid optical transmission system 490 may be implemented within the hybrid network interface controller described with respect to previous figures (e.g., FIGS. 1A-1B), or as part of the optical module 116 or wireless module 124 previously described. In some aspects, the hybrid optical transmission system 490 provides a unified signal generation architecture that supports both optical and wireless transmission paths, enhancing system flexibility and resource utilization.

The hybrid optical transmission system 490 receives an electrical input signal as input 432, which may be the same as or similar to the input 432 described with respect to FIGS. 4B and 4C. The input 432 may represent digital data from a MAC circuit, controller, or host interface within the hybrid network interface controller. In some aspects, the input 432 may be provided to one or more suitable signal conditioning circuitry such as impedance matching networks, level shifters, or input buffers to ensure proper signal integrity when transferring data from digital processing circuits to the optical modulation components. The input 432 may be of various input formats, including serial data streams, parallel data buses, or differential signaling, depending on the specific implementation requirements. In some aspects, the input 432 may include protocol-specific framing or formatting logic according to relevant communication standards before encoding.

The input 432 is provided to an encoder 434, which may be the same as or similar to the encoder 434 described with respect to FIGS. 4B and 4C. The encoder 434 performs signal encoding operations to prepare the electrical data for optical modulation. In some aspects, the encoder 434 may implement various signal processing operations, including but not limited to data framing, scrambling, encryption, FEC, interleaving, or protocol-specific encoding. The encoder 434 may generate an encoded data stream suitable for optical modulation, potentially incorporating line coding schemes such as 8b/10b, 64b/66b, or more advanced modulation formats depending on the system requirements and target performance metrics. In some implementations, the encoder 434 may support multiple encoding modes or adaptable encoding parameters that can be dynamically configured based on operating conditions, quality of service requirements, or system directives. The encoder 434 may be implemented using dedicated DSP circuitry, an ASIC, an FPGA, or other suitable digital logic.

The encoded signal from the encoder 434 is provided to a modulator 462, which may be the same as or similar to the modulator 462 described with respect to FIG. 4C. The modulator 462 may be configured to convert the encoded electrical data into corresponding optical signal variations. The modulator 462 receives an optical carrier 464, which may be the same as or similar to the optical carrier 464 described with respect to FIG. 4C. The optical carrier 464 may comprise a continuous-wave laser signal generated by a laser diode, semiconductor laser, or other coherent light source. In some implementations, the optical carrier 464 may be produced by an optical synthesizer, wavelength-tunable laser, or frequency-locked optical source that provides precise spectral characteristics suitable for both optical communication and photonic mixing applications. The optical carrier 464 may operate at wavelengths compatible with optical communication standards, such as 850 nm for multi-mode transmission or 1310/1550 nm for single-mode applications. In some aspects, the optical carrier 464 may include stabilization circuitry to maintain wavelength accuracy, power control mechanisms to ensure appropriate optical output levels, and monitoring capabilities to ensure proper operation.

The modulator 462 modulates the optical carrier 464 based on the encoded signal, creating a modulated optical signal that carries the encoded information. As illustrated in FIG. 4D, a photonic signal generator may include the encoder 434, the optical modulator 462, and the optical carrier 464. The modulated optical output from the modulator 462 is directed to a branching module 492. The branching module 492 represents may enable the selective routing of the modulated optical signal to different system outputs according to operational requirements. The branching module 492 may be implemented using various optical components, including but not limited to optical switches, splitters, directional couplers, wavelength-selective elements, or photonic integrated circuit routing structures. In some aspects, the branching module 492 may incorporate active components such as electro-optic switches or thermo-optic tuning elements that allow dynamic control of the optical path selection. Alternatively, the branching module 492 may utilize passive optical splitting with downstream optical path selection or attenuation to direct optical power according to system needs. The branching module 492 may be controlled by digital signals from the system controller, configuration memory, or other control logic that determines the appropriate routing path based on the current operational mode, performance requirements, or fault conditions.

The branching module 492 may be configured to route the modulated optical signal along one of multiple selectable paths, enabling the hybrid optical transmission system 490 to support dual functionality through shared front-end processing. In a first path, the modulated optical signal may be directed to an optical output 414, which may be the same as or similar to the optical output 414 described with respect to FIG. 4A. The optical output 414 is configured for standard optical transmission through a fiber optic connector to a remote receiver. When the modulated optical signal is routed to the optical output 414, the hybrid optical transmission system 490 operates as a conventional optical transmitter, enabling communication via optical fiber or other waveguide media. The optical output 414 may include coupling elements such as lenses, waveguides, or fiber alignment structures that efficiently transfer the modulated light into an external optical fiber or waveguide. In some implementations, the optical output 414 may include optical isolation components to prevent back-reflections from disrupting the laser operation.

In an alternative path, the modulated optical signal may be delivered to a uni-traveling carrier (UTC) photodiode 466, which may be the same as or similar to the UTC photodiode 466 described with respect to FIG. 4C. The UTC photodiode 466 is configured for photonic RF generation, converting the optical signal into a high-frequency electrical signal suitable for wireless transmission or further RF processing. When the modulated optical signal is routed to the UTC photodiode 466, the hybrid optical transmission system 490 is a photonic wireless signal generator, enabling communication via millimeter-wave or terahertz wireless channels. The UTC photodiode 466 performs photonic mixing of the modulated carrier with a reference optical signal (not shown in FIG. 4D but described with respect to FIG. 4C) to generate a high-frequency electrical RF signal. The photonic mixing process may use optical heterodyning, where the beating of two optical frequencies with a controlled frequency difference generates an electrical signal at their difference frequency.

The UTC photodiode 466 and optical output 414 is indicated using dashed lines in FIG. 4D to reflect that their use may be optional or dynamically selectable based on system configuration, where system components may be activated or deactivated according to operational requirements, thereby conserving power or resources when certain functions are not needed.

FIG. 4E is a simplified schematic illustration of the photonic mixing stage 465 referenced in FIG. 4C and/or FIG. 4D. In some aspects, the photonic mixing stage 465 includes a UTC photodiode 466 that receives two optical input signals, labeled Optical Signal 1 and Optical Signal 2. These signals may originate from separate continuous-wave laser sources, and their optical frequency difference defines the output signal frequency. The UTC photodiode 466 performs optical heterodyning to produce an electrical wave signal at a frequency corresponding to the beat frequency between the two optical inputs. This high-frequency electrical signal may be used for generating mmWave or terahertz-band wireless transmissions in a hybrid network interface controller.

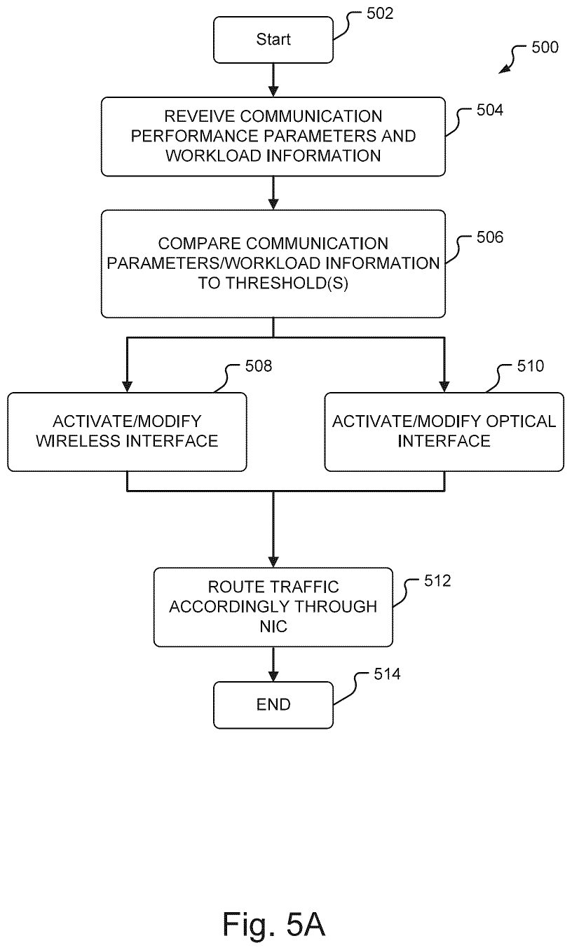

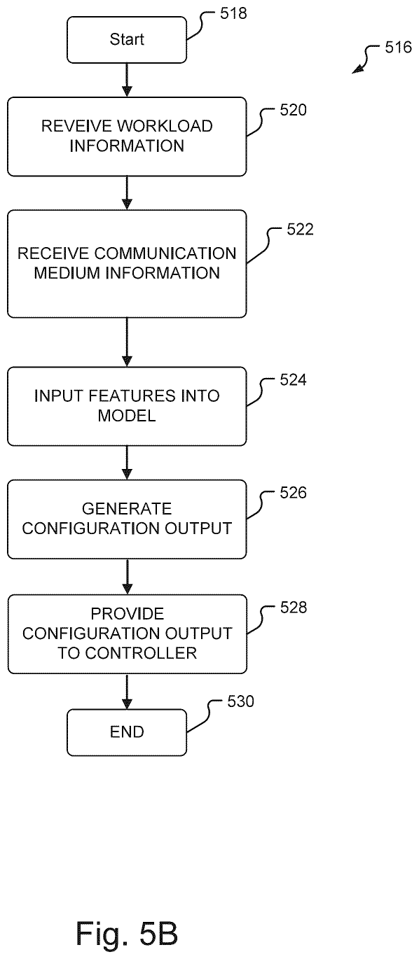

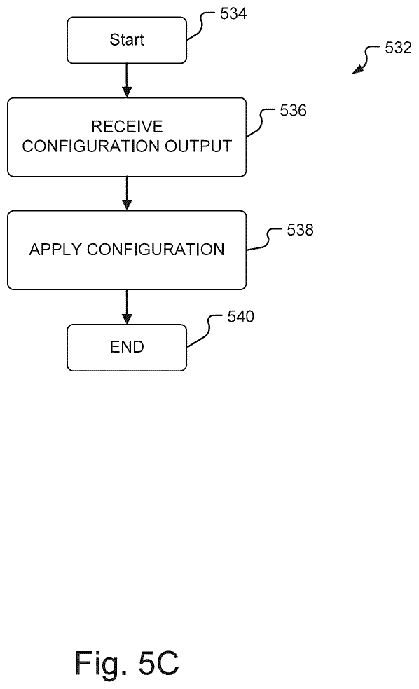

Referring now to FIG. 5A, a flowchart illustrating an example method 500 for dynamically selecting or modifying an active communication interface based on monitored communication and workload conditions is depicted in accordance with at least one aspect of the present disclosure. The method 500 may be implemented by a controller, such as controller 112 described with reference to FIGS. 1A-2D, within a hybrid network interface controller or device to enable adaptive selection between optical and wireless communication interfaces.

The method 500 begins at a start block 502, which represents initialization of the interface selection process. The start block 502 may be triggered by various events, including but not limited to: system startup, periodic evaluation intervals, detection of changed network conditions, receipt of configuration commands from a host system or orchestrator, or in response to specific application requests. In some implementations, the start block 502 may include initialization of monitoring components, loading of threshold parameters from configuration memory, or resetting of state variables used in subsequent decision processes.

From start block 502, the method 500 proceeds to block 504, where the system receives communication performance parameters and workload information. Block 504 represents a data collection phase during which a controller gathers relevant metrics and contextual information necessary for making informed interface selection decisions. The communication performance parameters may comprise a diverse set of measurements and indicators that characterize the current operating state of both the optical interface and wireless interface.

As previously described, the communication performance parameters may include, but are not limited to, SNR measurements that quantify the ratio of desired signal power to background noise power, latency measurements indicating transmission delay across the communication medium, throughput metrics representing actual data transfer rates achieved, congestion indicators showing resource contention or bandwidth saturation, and error rate values such as BER or packet error rate (PER) for both optical and wireless communication links. In some implementations, the communication performance parameters may include statistical aggregates such as moving averages, variance indicators, or trend analyses that provide historical context beyond instantaneous measurements.

As previously described, the workload information collected at block 504 may include parameters that characterize the requirements, priorities, or constraints of the data flows that will traverse the communication interfaces. This workload information may indicate attributes such as the priority level of data (e.g., mission-critical versus background transfers), latency sensitivity (e.g., real-time applications versus bulk data transfers), or bandwidth demands (e.g., high-definition video streaming versus telemetry data) associated with a given data stream, application, or virtual machine. The workload information may be derived from various sources, including packet header fields, quality-of-service (QoS) tags, application profiles, or explicit directives from workload management systems. In some aspects, the workload information may include forward-looking indicators such as anticipated traffic bursts, scheduled data transfers, or resource reservations that allow proactive interface selection before actual data transmission begins.

The collection mechanisms implemented at block 504 may include direct polling of interface hardware registers, reception of telemetry data from monitoring agents, sampling of traffic statistics from buffer management systems, or processing of control plane messages from external orchestration systems. In some implementations, the data collection may occur at different sampling rates for different parameters, with some metrics captured at higher frequencies than other metrics which may change slower.

Upon collecting the communication performance parameters and workload information at block 504, the method 500 proceeds to block 506, where the system compares the communication performance parameters and workload information to one or more defined thresholds. Block 506 represents an evaluation phase during which the collected data is analyzed against established criteria to determine appropriate interface configuration actions.

The thresholds referenced at block 506 may comprise various types of decision criteria. These thresholds may be statically configured through administrative policies or device configuration, dynamically computed based on current system state or resource availability, or learned through machine learning processes that analyze historical behavior to identify optimal operating points. The thresholds may include simple numeric cutoff values (e.g., “activate wireless interface if optical link BER exceeds 10\hat{ }-9”), conditional expressions that combine multiple parameters (e.g., “switch to optical-only mode if wireless SNR falls below 15 dB AND optical link utilization is below 60%”), or complex decision boundaries generated by machine learning models as described in relation to FIGS. 3A and 3B.

In some implementations, the comparison operation at block 506 may involve multiple threshold evaluations performed in parallel, with a weighted scoring system or decision tree determining the final outcome based on the combination of individual comparisons. The comparison may incorporate hysteresis mechanisms to prevent rapid oscillation between interfaces when measurements fluctuate near threshold boundaries, or include dampening factors that consider the stability duration of a condition before triggering configuration changes.

Following the threshold comparison at block 506, the method 500 reaches decision points 508 and 510, which represent branch points in the control flow based on the evaluation outcome. At decision point 508, the system determines whether to activate or modify the wireless interface based on the comparison outcome from block 506. Similarly, at decision point 510, the system determines whether to activate or modify the optical interface based on the comparison outcome.

The decision points 508 and 510 may be implemented as independent evaluations that can result in concurrent actions on both interfaces, rather than mutually exclusive branches. Such independence enables the system to support various operating modes, including single-interface operation (either optical or wireless), dual-interface operation with traffic separation, or load-balancing across both interfaces.

The activation or modification actions determined at decision points 508 and 510 may include enabling or disabling a particular interface (e.g., powering up or shutting down interface circuitry), adjusting interface operating parameters (e.g., modifying transmission power levels, changing modulation schemes, updating protocol timing parameters), or transitioning between operational modes (e.g., switching from single-interface to dual-interface operation, or vice versa). In some implementations, the actions may include more granular configurations such as activating specific lanes or wavelengths within an optical interface, or selecting particular frequency bands or spatial streams within a wireless interface.

After the interface configuration decisions are made at points 508 and 510, the method 500 proceeds to block 512, where traffic is routed through the network interface controller based on the activated or modified interface configuration. Block 512 represents the implementation phase where data flow paths are established according to the selected interface configuration. The routing operation may involve configuring packet steering rules, updating forwarding tables, programming switching elements, or adjusting buffer allocation to direct traffic flows through the appropriate interfaces.

In some implementations, the traffic routing at block 512 may include flow-based differentiation, where different data streams are directed to different interfaces based on their characteristics or requirements. For example, delay-sensitive traffic may be routed through the interface offering lowest latency, while bulk data transfers may be directed to the interface with highest available bandwidth. The routing configuration may incorporate load-balancing algorithms that distribute traffic across multiple active interfaces to optimize resource utilization or redundancy mechanisms that duplicate critical traffic across both interfaces to enhance reliability.

The method 500 concludes at block 514, which represents completion of the current interface selection and configuration cycle. In some implementations, reaching block 514 may trigger a delay interval before restarting the method at block 502, establishing a periodic evaluation pattern. Alternatively, the system may remain at block 514 until an event-based trigger initiates a new evaluation cycle, such as detection of changed network conditions, receipt of new workload information, or explicit reconfiguration commands.

It should be noted that the method 500 may operate autonomously within the network interface controller as a self-contained control loop, or may be informed by higher-level control signals from host systems, network orchestrators, or management planes. The interface selection decisions may incorporate broader contextual information beyond the immediate performance parameters and workload characteristics, including system-level considerations such as energy efficiency targets, thermal management constraints, or fault tolerance requirements.

In some aspects, dual-mode operation (e.g., where both the optical and wireless interfaces are simultaneously active) may be triggered based on considerations beyond simple threshold evaluation. Such considerations may include resource availability across the broader network, redundancy requirements for mission-critical applications, or policy-driven criteria established through administrative configuration. The dual-mode operation may be implemented in various configurations, including active-active arrangements where both interfaces carry traffic concurrently, active-standby arrangements where one interface serves as a backup, or specialized arrangements where interfaces are dedicated to particular traffic classes.

Referring now to FIG. 5B, a flowchart illustrating an example method 516 for generating communication interface configuration output using a decision model is depicted in accordance with at least one aspect of the present disclosure. The method 516 may be implemented by a controller, such as controller 112 described with reference to FIGS. 1A-2D, within a hybrid network interface controller or device, or by an external configuration generation system as described with reference to FIG. 2C. The method 516 may enable model-driven selection between optical and wireless communication interfaces based on workload characteristics and communication medium performance metrics.

The method 516 begins at a start block 518, which represents initialization of the model-based configuration generation process. The start block 518 may be triggered by various events, including but not limited to: system startup, periodic evaluation intervals, detection of changed network conditions, receipt of new workload information, or explicit configuration update requests. In some implementations, the start block 518 may include initialization of model parameters, loading of trained model weights from non-volatile storage, or preparation of input feature vectors for subsequent processing operations.

From start block 518, the method 516 proceeds to block 520, where the system receives workload information. Block 520 represents a data acquisition phase during which the system gathers contextual information related to the data traffic that will traverse the communication interfaces. The workload information collected at block 520 may include parameters that characterize the requirements, priorities, or constraints of current or anticipated data flows.

In some aspects, the workload information may include attributes such as priority level indicators that classify data according to operational importance (e.g., mission-critical, business-critical, or background), latency sensitivity metrics that quantify timing constraints for different applications (e.g., real-time, interactive, or batch processing), bandwidth demand estimations that project data transfer volume requirements (e.g., peak rates, sustained throughput, or burstiness patterns), or application-specific requirements such as security, reliability, or energy efficiency constraints. The workload information may further include traffic type classifications (e.g., streaming media, database transactions, file transfers, or control messages), session duration predictions indicating expected connection lifetimes, or quality-of-service (QoS) parameters that establish performance expectations for different data categories.

The workload information may be derived from various sources, including but not limited to: packet inspection mechanisms that analyze header fields or traffic patterns, application programming interfaces (APIs) that receive explicit declarations from software components, workload management systems that track resource allocations and reservations, virtual machine managers or container orchestrators that monitor application behavior, or policy engines that apply administrative directives to different traffic classes. In some implementations, the workload information may include historical patterns or statistical models that predict future resource requirements based on observed behavior, enabling proactive configuration adjustments before actual demand materializes.

Following the workload information acquisition at block 520, the method 516 proceeds to block 522, where the system receives communication medium information. Block 522 represents a complementary data collection phase focused on the operational status and performance characteristics of the available communication interfaces. The communication medium information collected at block 522 may comprise measurements and indicators that characterize the current operating state of the optical interface and/or the wireless interface.

In some aspects, the communication medium information may include metrics such as signal quality measurements that quantify transmission fidelity (e.g., signal-to-noise ratio, bit error rate, or eye diagram parameters), bandwidth availability indicators that assess current capacity (e.g., link utilization percentage, available data rate, or congestion indicators), latency measurements that characterize transmission delay (e.g., round-trip time, jitter, or propagation delay), or reliability statistics that reflect link stability (e.g., packet loss rate, retransmission count, or link state transitions). The communication medium information may further include power consumption data related to each interface, spectral efficiency metrics for wireless communications, attenuation measurements for optical links, or environmental factors that influence performance such as temperature, vibration, or electromagnetic interference levels.

The communication medium information may be obtained through various monitoring mechanisms, including but not limited to: hardware registers that expose physical layer statistics, specialized telemetry components that measure signal characteristics, performance counters that track protocol-level events, or diagnostic routines that actively probe interface capabilities. In some implementations, the communication medium information may incorporate predictive elements derived from trend analysis, seasonal patterns, or environmental correlations that anticipate potential performance variations before they manifest as observable degradation.

Upon collecting both workload information and communication medium information at blocks 520 and 522, the method 516 proceeds to block 524, where the system inputs the collected features into a model. At block 524, contextual information about workload requirements and interface capabilities is processed through a structured decision framework to determine optimal interface selection.

The model referenced at block 524 may be a model configured to translate input features into configuration decisions based on learned patterns, programmed logic, or optimization strategies. In some aspects, the model may be implemented as a rule-based decision engine that applies conditional logic to input parameters, a decision tree that recursively partitions the feature space according to value thresholds, a statistical classifier that assigns configuration outcomes based on feature distributions, or a machine learning model such as a neural network, support vector machine, or ensemble method that leverages supervised learning to capture complex relationships between inputs and outcomes. The model architecture may be selected based on factors such as interpretability requirements, computational efficiency constraints, or accuracy targets for different operational scenarios.

In some implementations, the model may have been previously trained through processes similar to those described with reference to FIG. 3A, using historical data that associates workload characteristics and communication medium states with optimal interface configurations. Such training may employ supervised learning techniques where ground truth labels are derived from observed performance outcomes, reinforcement learning approaches that optimize configuration policies through iterative interaction with the environment, or hybrid strategies that combine domain expertise with data-driven discovery. The model may incorporate various regularization techniques to enhance generalization performance across diverse operational conditions, prevent overfitting to training examples, or accommodate noisy or incomplete input data.

The feature inputs provided to the model at block 524 may undergo preprocessing operations to improve their utility for decision-making. These operations may include normalization to establish consistent scale across different metrics, feature encoding to transform categorical variables into numeric representations, missing value imputation to handle incomplete telemetry, and/or dimensionality reduction to identify principal components or latent factors that capture feature variation while reducing computational complexity. In some aspects, the input features may be structured as feature vectors, tensors, or graph representations depending on the model architecture and the nature of the relationships between different parameters.

Following the processing of input features through the model at block 524, the method 516 proceeds to block 526, where the model generates a configuration output. Block 526 represents the production of actionable directives that determine how data will be routed through the available communication interfaces of the hybrid network interface controller. The configuration output represents the model's determination of optimal interface allocation based on the provided workload and medium information.

In some aspects, the configuration output may specify interface selection directives that determine which communication paths should be activated or deactivated (e.g., “use optical interface only,” “use wireless interface only,” or “enable both interfaces concurrently”), routing policies that govern traffic distribution across active interfaces (e.g., application-based routing, flow-based separation, or load balancing percentages), operational parameters that tune interface behavior (e.g., transmission power levels, packet sizing, or protocol timing values), or state transition directives that establish conditions for dynamic reconfiguration (e.g., failover thresholds, hysteresis bands, or stability timers). The configuration output may further include confidence scores or uncertainty estimates that reflect the model's certainty in its recommendations, enabling risk-aware decision-making in ambiguous scenarios.

The configuration output generated at block 526 may be represented in various formats, including but not limited to: binary flags indicating interface activation states, enumerated values representing operational modes, floating-point parameters specifying resource allocation proportions, structured objects encapsulating multiple configuration dimensions, or hierarchical policies that combine high-level directives with low-level parameter settings. The format may be determined by the model architecture, the capability requirements of downstream components, or the complexity of the configuration space being addressed.

After the model generates the configuration output at block 526, the method 516 proceeds to block 528, where the system provides the configuration output to a controller. Block 528 represents the transfer of decision outcomes from the model to an execution entity responsible for implementing the selected configuration. The controller referenced at block 528 may comprise various components depending on the system architecture, including but not limited to: a local controller integrated within the network interface controller (e.g., controller 112 described with reference to FIGS. 1A-2D), a host system processor that manages peripheral devices, or an external orchestration agent that coordinates network resources across multiple devices.

The delivery mechanism employed at block 528 may vary based on the relationship between the model and the controller. In configurations where the model operates within the same processing domain as the controller, the configuration output may be transferred through direct function calls, shared memory structures, or internal message queues. In distributed architectures where the model operates on a separate system from the controller, the configuration output may be transmitted through network communication protocols, remote procedure calls, or management interfaces that couple different administrative domains. The delivery mechanism may incorporate reliability features such as acknowledgment mechanisms, delivery confirmation, or idempotent operations to ensure configuration directives are properly received and applied.

The method 516 concludes at block 530, which represents completion of the current configuration generation cycle. In some implementations, reaching block 530 may trigger a delay interval before restarting the method at block 518, establishing a periodic evaluation pattern. Alternatively, the system may remain at block 530 until an event-based trigger initiates a new evaluation cycle, such as detection of changed network conditions, receipt of new workload information, or explicit reconfiguration commands. The frequency of configuration updates may be tuned based on factors such as the volatility of network conditions, the diversity of workload characteristics, or the computational overhead associated with model evaluation.

In some embodiments, the model-based configuration generation process illustrated in FIG. 5B may operate concurrently with threshold-based approaches such as those described with reference to FIG. 5A, providing complementary decision mechanisms that address different operational scenarios or time scales. The integration of these approaches may leverage techniques such as decision fusion, where outputs from multiple decision systems are combined according to confidence weighting, specialization mapping that directs different classes of decisions to the most suitable approach, or hierarchical organization where one approach provides high-level directives while another handles detailed implementation.

Referring now to FIG. 5C, a flowchart illustrating an exemplary method 532 for applying a configuration output to a hybrid network interface controller is shown in accordance with at least one aspect of the present disclosure. The method 532 represents a process for implementing configuration directives within a hybrid network interface device, such as the hybrid network interface controller described with respect to previous figures. The method 532 may be executed by a controller, such as controller 112 described with reference to FIGS. 1A-2D, or by configuration application logic residing within the hybrid network interface controller.

The method 532 begins at a start block 534, which represents initialization of the configuration application process. The start block 534 may be triggered by various events, including but not limited to: receipt of a new configuration directive, detection of a configuration update notification, expiration of a configuration refresh timer, or activation of a configuration change handler in response to system events. In some aspects, the start block 534 may include preparation operations such as acquiring configuration locks to prevent concurrent modification, initializing state variables used during configuration application, or establishing transactional boundaries that enable configuration changes and/or the rollback of configuration changes. The start block 534 may also include a validation step as one or more preconditions necessary for configuration modification, such as verifying operational status of affected components, checking resource availability, or confirming authorization for the requested changes.

From start block 534, the method 532 proceeds to block 536, where the system receives configuration output. Block 536 represents acquisition of configuration directives that specify desired operational parameters, interface selections, or routing behaviors for the hybrid network interface controller. The configuration output received at block 536 may originate from various sources, including but not limited to: a model-based configuration generator as described with reference to FIG. 5B, an external orchestration system such as a software-defined networking (SDN) controller, a network management platform, a policy engine, or a host system driver or management agent. The configuration output may be delivered through various mechanisms, including control plane messages, management interface commands, memory-mapped registers, or inter-process communication channels depending on the system architecture and relationship between configuration generators and consumers.

In some aspects, the configuration output may comprise structured data specifying operational directives for one or more components of the hybrid network interface controller. This structured data may include parameters such as interface activation indicators that specify which communication interfaces should be enabled or disabled (e.g., optical active, wireless inactive), traffic routing rules that determine how data flows should be distributed across available interfaces (e.g., high-priority traffic via optical, background transfers via wireless), performance parameters that govern interface behavior (e.g., transmission power levels, protocol timing values, buffer allocation), and/or state transition directives that establish conditions for dynamic reconfiguration (e.g., failover thresholds, stability timers). The configuration output may be encoded in various formats, including binary control structures, JSON or XML documents, key-value pairs, protocol buffers, or proprietary representation formats optimized for efficient processing or minimal storage requirements.

The reception operation at block 536 may include preprocessing steps such as decoding serialized configuration representations, validating configuration syntax and semantics, resolving dependencies between configuration elements, or translating high-level directives into device-specific settings. In some implementations, the reception operation may incorporate filtering or transformation logic that adapts generalized configuration directives to the specific capabilities and constraints of the current hardware platform, ensuring portability across different device generations or variants.

Upon receiving the configuration output at block 536, the method 532 proceeds to block 538, where the system applies the configuration. Block 538 represents the execution phase during which configuration directives are transformed into operational state changes within the hybrid network interface controller. The application operation may encompass various actions depending on the nature and scope of the configuration directives, including but not limited to: modifying register values that control hardware component behavior, updating routing tables or flow classifiers that determine data path selection, adjusting buffer allocations or quality-of-service parameters that influence performance characteristics, or reconfiguring protocol engines that implement communication standards.

In some aspects, the application operation at block 538 may be organized as a multi-phase process that ensures consistency and minimizes service disruption during configuration changes. This process may include preparation stages where resources are allocated and validated before modification, execution stages where actual state changes are performed, and verification stages where the applied configuration is tested for correctness and stability. The application operation may incorporate transactional semantics that enable atomic application of related configuration changes, ensuring that the system either fully applies a consistent configuration set or maintains its previous state if errors occur during application.

For interface-specific configurations, the application operation may include hardware-level actions such as enabling or disabling power to transmit or receive circuits, configuring physical layer parameters such as modulation schemes or signal levels, or updating media access control settings that govern protocol behavior. For routing configurations, the application operation may modify packet steering rules, update flow tables, or reconfigure switching elements to direct traffic according to specified policies or workload characteristics. For adaptive configurations, the application operation may adjust thresholds, monitoring parameters, or decision criteria used by control algorithms that dynamically optimize interface selection based on operating conditions.

The method 532 concludes at block 540, which represents completion of the configuration application process. In some implementations, reaching block 540 may trigger notification mechanisms that inform interested components or systems about the configuration change, allowing them to adapt their behavior accordingly. Such notifications may be delivered to host systems to update their understanding of available communication paths, to performance monitoring systems to establish appropriate baseline measurements for the new configuration, or to higher-level orchestration systems to confirm successful application of requested settings. The completion phase may also include cleanup operations such as releasing configuration locks, finalizing transaction journals, or updating configuration version indicators to track applied changes for audit or rollback purposes.

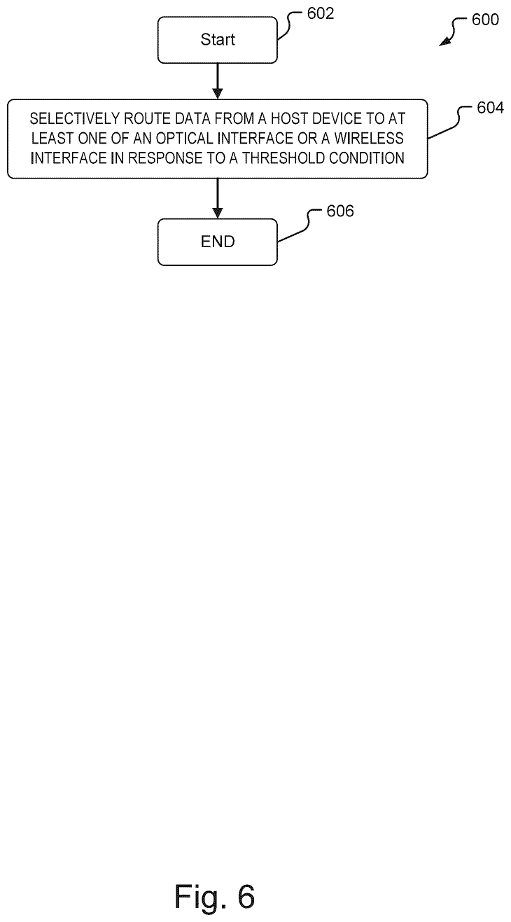

Referring now to FIG. 6, a flowchart illustrating a method 600 for dynamically selecting between optical and wireless communication interfaces using AI-based decision logic is depicted, in accordance with aspects of the present disclosure, at least some concepts of which have been discussed with reference to FIGS. 1-5C. The method 600 may be performed by one or more control elements within the hybrid network interface controller 100A/100B described with reference to FIGS. 1A and 1B, such as the controller 112, communication medium selector 202A/202B, and model 204. In one aspect, method 600 can be implemented in one or more circuits. As may be appreciated, the one or more circuits may be included in the controller 112, the communication medium selector 202A/202B of FIGS. 2A and 2B, and/or correspond to or involve elements described in the hybrid optical transmission system 490 of FIG. 4D.

The method 600 begins at block 602, which represents a start condition for the data routing process. The method proceeds to block 604, where a hybrid network interface device selectively routes data from a host device to at least one of an optical interface or a wireless interface in response to a threshold condition. That is, the hybrid network interface device may dynamically determine which communication medium to utilize based on various operational parameters that may trigger the threshold condition.

The threshold condition referenced in block 604 may be based on various factors, including but not limited to, measured communication link quality metrics, bandwidth utilization, detected bit-error rates, or signal-to-noise ratios associated with the optical and wireless communication media. In some aspects, the threshold condition may incorporate workload demands, traffic priority levels, or may be determined through AI-based decision logic that analyzes usage metrics collected from both interfaces.

After completing the selective routing operation, the method 600 proceeds to block 606, which represents the end of the current routing decision cycle.

In some aspects of method 600, the one or more circuits are further to at least one of: switch data transmission from a first communication medium to a second communication medium; or enable both communication media concurrently.

In some aspects of method 600, the one or more circuits are further to route data via both the optical interface and the wireless interface in response to the threshold condition.

In some aspects of method 600, the threshold condition is based on at least one of: a measured communication link quality metric associated with at least one of the optical communication medium or the wireless communication medium; a measure of bandwidth utilization associated with at least one of the optical communication medium or the wireless communication medium; a detected bit-error rate associated with at least one of the optical communication medium or the wireless communication medium; or a signal-to-noise ratio associated with at least one of the optical communication medium or the wireless communication medium.

In some aspects of method 600, the one or more circuits are further to: receive an indication of a workload demand; and compare the indication of the workload demand to the threshold condition.

In some aspects of method 600, the one or more circuits are further to: route high-priority workload traffic through the optical interface; and route lower-priority workload traffic through the wireless interface.

In some aspects of method 600, the one or more circuits include a local memory storing artificial intelligence (AI)-based decision logic, and the threshold condition is determined by the AI-based decision logic in response to usage metrics collected from the optical interface and the wireless interface.

In some aspects of method 600, the threshold condition is triggered in response to receiving a switching command from an external orchestration controller in a data center network.

In some aspects of method 600, the network interface device may include an interface to couple the network interface device to the host device, wherein the interface is further to communicate with the host device using at least one of an optical pathway or an electrical pathway.

In some aspects of method 600, the wireless interface comprises at least one of: a photonic mixing stage to generate optical signal; or a radio frequency mixing stage configured to generate or receive millimeter-wave or terahertz signals.

In some aspects of method 600, the network interface device may include a photonic signal generator to generate a modulated optical signal; and a branching module to direct the modulated optical signal to at least one of the optical interface or the wireless interface.

In some aspects of method 600, the network interface device may include an optical output coupling the modulated optical signal to an optical fiber.

In some aspects of method 600, the wireless interface includes: a photonic mixing stage to generate a millimeter-wave or terahertz signals; and an antenna coupled to the photonic mixing stage.

In view of the above, it should be appreciated that aspects of the present disclosure provide a network interface device comprising: an optical interface to receive a modulated optical signal; optical processing circuitry to demodulate the modulated optical; a wireless interface to receive a wireless signal; wireless processing circuitry to decode the wireless signal; and one or more output circuits coupled to the optical processing circuitry and the wireless processing circuitry, the one or more output circuits to provide demodulated data to a host system. In some aspects, the network interface device includes a controller communicatively coupled to the optical processing circuitry and the wireless processing circuitry, the controller to: monitor at least one link-quality metric associated with the optical interface and the wireless interface; and selectively enable or disable reception through at least one of the optical interface or wireless interface based on a threshold condition. In some aspects, the controller is further to receive data concurrently over the optical interface and the wireless interface in response to detecting that at least one of an overall bandwidth demand or a link utilization meets or exceeds the threshold condition. In some aspects, the controller comprises artificial intelligence (AI)-based decision logic to modify the threshold condition based on the at least one link-quality metric.

In view of the above, it should be appreciated that aspects of the present disclosure provide system comprising: a host device to generate outgoing data traffic; a network interface device communicatively coupled to the host device, the network interface device comprising: an optical interface to transmit data over an optical communication medium, a wireless interface to transmit data over a wireless communication medium, and a controller to selectively route the outgoing data traffic between the optical interface and the wireless interface based on a threshold condition. In some aspects, the network interface device further comprises: optical processing circuitry to demodulate inbound optical signals from the optical communication medium; and wireless processing circuitry to decode inbound wireless signals from the wireless communication medium, and wherein the controller is further to route incoming data to the host device. In some aspects, the controller comprises an artificial intelligence module to: monitor link performance metrics from the optical interface and the wireless interface; and dynamically adjust the threshold condition in response to changes in the link performance metrics. In some aspects, the host device comprises a workload manager that assigns a priority indicator to outgoing data, and the controller is to route higher-priority traffic over the optical interface and lower-priority traffic over the wireless interface.

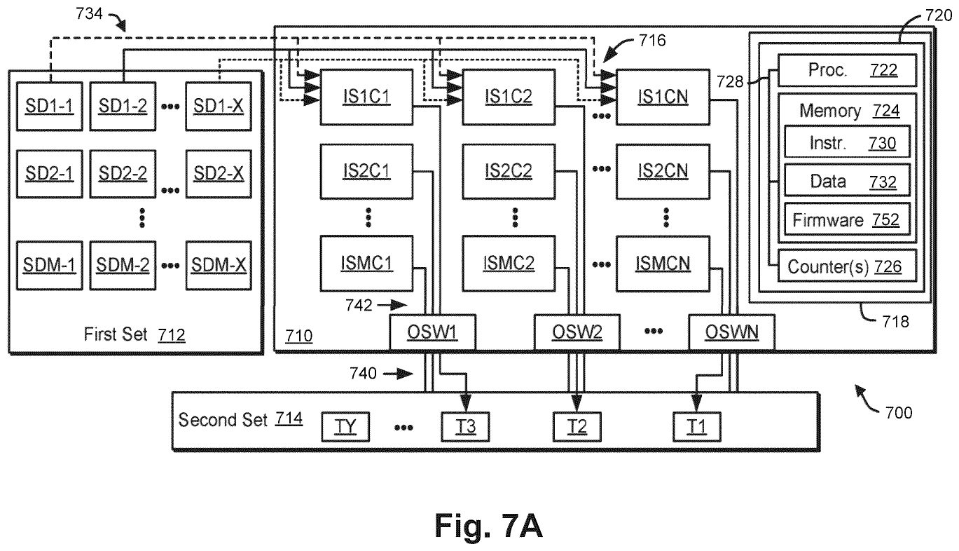

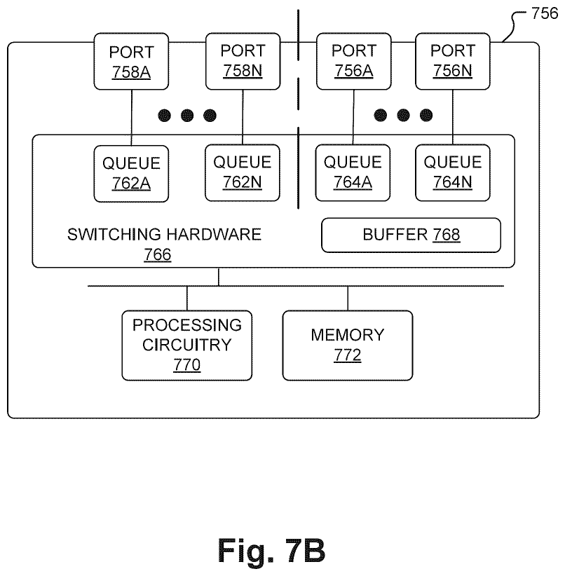

FIG. 7A illustrates a block diagram of a system 700 that includes switching circuitry 710 (sometimes referred to as a “fabric”) positioned between first and second sets 712 and 714 of devices, in accordance with at least one embodiment. The switching circuitry 710 may be implemented by an hybrid switch (e.g., switch 756 of FIG. 7B) supporting both wired and wireless communication. By way of a non-limiting example, the system 700 may be implemented as a GPU-to-GPU link system (e.g., a NVLINK® GPU-to-GPU interconnect system) in which the switching circuitry 710 may include one or more GPU-to-GPU switches (e.g., one or more NVSWITCH™ switches). The system 700 may implement (e.g., be a component of) other systems, such as a data center, a cloud computing system, a machine learning system (e.g., utilizing one or more neural networks), an autonomous vehicle, medical imaging equipment, and/or the like.

Each of the first and second sets 712 and 714 may be implemented as a GPU, a parallel processing unit, a central processing unit (“CPU”), data processing unit (“DPU”), a controller, a switch, switching circuitry, a memory device, and/or the like. By way of a non-limiting example, the first set 712 has been illustrated as including a number “M*X” of devices, which are illustrated as devices SD1-1 to SDM-X. However, the set 712 may include any number of devices including a single device. For ease of illustration, in FIG. 7A, the devices SD1-1 to SDM-X have been illustrated as being arranged in a two-dimensional array that includes a number “M” of rows and a number “X” of columns. The second set 714 has been illustrated as including a number “Y” of devices, which are illustrated as devices T1-TY, but the second set 714 may include any number of devices including a single device. Further, one or more devices may be members of both of the sets 712 and 714. Thus, the sets 712 and 714 are not mutually exclusive and may include one or more of the same devices. Therefore, in at least one embodiment, the switching circuitry 710 may allow any of the devices SD1-1 to SDM-X in the first set 712 to communicate with any of the devices SD1-1 to SDM-X in the first set 712 and/or any of the devices T1-TY in the second set 714. Further, in at least one embodiment, the switching circuitry 710 may allow any of the devices T1-TY in the second set 714 to communicate with any of the devices T1-TY in the second set 714 and/or any of the devices SD1-1 to SDM-X in the first set 712.

The switching circuitry 710 may include a number “N” of outbound switches OSW1-OSWN, a predetermined number “M*N” of internal switches IS1C1-ISMCN, signal conductors 716, and a route block 718 that controls the operations of the internal switches IS1C1-ISMCN. The route block 718 has been illustrated as including hardware 720 that may include at least one processor 722, memory 724, and one or more counters 726. In at least one embodiment, each of the processor(s) 722 may be implemented as one or more hardware state machines, one or more microprocessors, one or more microcontrollers, one or more controllers, or the like. The memory 724 (e.g., one or more non-transitory processor-readable medium) may be implemented, for example, using volatile memory (e.g., dynamic random-access memory (“DRAM”)) and/or nonvolatile memory (e.g., a hard drive, a solid state device (“SSD”), and/or the like).

The signal conductors 716 interconnect the first set 712, the second set 714, the internal switches IS1C1-ISMCN, and the outbound switches OSW1-OSWN. In the example illustrated, the signal conductors 716 may include any number of signal conductors. The signal conductors 716 may each be implemented as a wire, a trace, and/or any other type of electrical conductor. As a non-limiting example, one or more of the signal conductors 716 may each be implemented as a wire-based serial near-range communications link. By way of another non-limiting example, one or more of the signal conductors 716 may each be implemented as a Scalable Link Interface (“SLI”).

In the embodiment illustrated, the signal conductors 716 include signal conductors 734, 740, and 742. The signal conductors 734 connect the devices SD1-1 to SDM-X to the internal switches IS1C1-ISMCN. For ease of illustration, only those of the signal conductors 734 that connect each of the devices SD1-1 to SD1-X to the internal switches IS1C1-IS1CN have been illustrated in FIG. 7A. In at least one embodiment, the internal switches IS1C1-IS1CN may each include a different port that is connected to each of at least a portion of the devices SD1-1 to SDM-X (e.g., the devices SD1-1 to SD1-X, respectively) by the signal conductors 734. Similarly, the internal switches IS2C1-IS2CN may each include a different internal port that is connected to each of at least a portion of the devices SD1-1 to SDM-X (e.g., the devices SD2-1 to SD2-X, respectively) by the signal conductors 734. Further, the internal switches ISMC1-ISMCN may each include a different internal port that is connected to each of at least a portion of the devices SD1-1 to SDM-X (e.g., the devices SDM-1 to SDM-X, respectively) by the signal conductors 734.

The signal conductors 742 connect the internal switches IS1C1-ISMCN to the outbound switches OSW1-OSWN. For example, at least one of the signal conductors 742 connects each of the internal switches IS1C1-ISMC1 to the outbound switch OSW1, at least one of the signal conductors 742 connects each of the internal switches IS1C2-ISMC2 to the outbound switch OSW2, and at least one of the signal conductors 742 connects each of the internal switches IS1CN-ISMCN to the outbound switch OSWN.

The signal conductors 740 connect the outbound switches OSW1-OSWN to the devices T1-TY. The outbound switches OSW1-OSWN may each include a different port that is connected by at least one of signal conductors 740 to at least one of the devices T1-TY.

While the switching circuitry 710 has been illustrated as including the internal switches IS1C1-ISMCN, the switching circuitry 710 may include any number of internal switches including a single internal switch. Further, the internal switches IS1C1-ISMCN have been illustrated as being arranged in a two-dimensional array that includes the number “M” of rows and the number “N” of columns. However, this is not a requirement and the internal switches IS1C1-ISMCN may positioned in alternate arrangements to implement any network topology, including a three-dimensional array. One or more of the internal switches IS1C1-ISMCN may be coupled to one another. For example, from the perspective of one of the internal switches IS1C1-ISMCN, one or more of the other internal switches IS1C1-ISMCN may be one of the devices T1-TY. Further, the switching circuitry 710 may be coupled to one or more switches (e.g., switching circuitry like the switching circuitry 710) that is/are external to the switching circuitry 710. For example, one or more of the devices SD1-1 to SDM-X and/or the devices T1-TY may each be implemented as an external switch.

The route block 718 may be connected to each of the internal switches IS1C1-ISMCN and/or each of at least a portion of the signal conductors 716 by one or more buses. For example, the processor(s) 722 and the memory 724 may be connected to one another by one or more buses 728. The bus(es) 728 may also connect the processor(s) 722 and the memory 724 to the internal switches IS1C1-ISMCN and/or each of at least a portion of the signal conductors 716. The memory 724 (e.g., a non-transitory processor readable media) stores instructions 730 that are executable by the processor(s) 722, data 732, and firmware 752, which may perform monitoring and data manipulation functions. For example, the firmware 752 may instruct the hardware 720 to transition one or more of the signal conductors 716, from the active state to the inactive state and vice versa.

FIG. 7B depicts a hybrid switch 756, as described in greater detail herein, which may enable communication between processing devices and/or client devices. The switch 756 may be capable of receiving and sending data, and may act as a central node in the network. Switch 756 may be wired in a topology including spine switches and top-of-rack (TOR) switches for example. Switch 756 may be capable of receiving, processing, and forwarding data, e.g., packets, to appropriate destinations within a network. In some aspects, such destinations may include, but are not limited to, processing devices and/or client devices. In some implementations, a switch 756, as described herein, may be included in a switch box, a platform, or a case that may contain one or more switches 756 and one or more power supply devices.

In some implementations, one or more processing devices may be connected to one or more ports of one or more switches 756 via network cables. In some aspects, one or more processing devices may be wirelessly connected to one or more ports of one or more switches 756. Processes, such as applications, executed by processing devices may involve transmitting data to nodes of the network, such as to other processing devices and/or to client devices. Data may flow through the network of processing devices and switch 756 using one or more protocols such as transmission control protocol (TCP), user datagram protocol (UDP), or Internet protocol (IP), for example. One or more switches 756 may, upon receiving data from a processing device or another switch 756, examine the data to identify a destination for the data and route the data through the network. In some aspects, the switch 756 may integrate one or more network interface controllers as describe with respect to FIG. 1A-1B.

In some implementations, a fabric may include wireless communication devices that establish wireless links between processing devices and/or switches 756. The wireless communication devices may utilize millimeter wave or terahertz frequencies to provide high-bandwidth, low-latency wireless connectivity suitable for data center applications. One or more switches 756 may incorporate hybrid connectivity capabilities, supporting both wired and wireless communication interfaces. Such hybrid switches 756 may enable dynamic allocation of communication resources based on workload prioritization, bandwidth requirements, and current network conditions.

In some aspects, the switch 756 may include a plurality of ports 758a-758n/760a-760n, switching hardware 766, processing circuitry 770, and memory 772. The switch 756 may include one or more ports 758a-758n/760a-760n configured to send and receive data in the form of packets, frames, and/or other units of information. The ports 758a-758n/760a-760n may be referred to as hardware ports, representing physical interfaces capable of handling communication through copper, fiber, or radio frequency links. Ports 758a-758n (wired) support transmission over physical cabling, while ports 760a-760n (wireless) support wireless communication protocols suitable for high-throughput data center environments. A “hardware port” may refer to a physical interface on a network switching device (also referred to as a switch and a network switch herein), such as an Ethernet or fiber-optic port, through which network packets are transmitted and received over physical media. A hardware port may be distinct from a “logical port,” which may refer to a software-defined endpoint identified by a numerical designation used to facilitate protocol-specific communication between networked devices at the transport or application layer. Although embodiments are discussed primarily involving hardware ports, embodiments of the present disclosure may also be applied to logical ports.

In some aspects, each port 758a-758n may support high-speed data transfers over physical cabling, such as copper or fiber-optic cables. In certain aspects, one or more ports 760a-760n may be compatible with one or more wireless transceivers. In some aspects, the ports 760a-760n may refer to a physical radio interface, logical port or SSID tied to a virtual access point, and/or a beamformed direction link to a specific destination node. The ports 758a-758n/760a-760n may be configured to accommodate one or more communication standards and protocols, including Ethernet, InfiniBand, and/or proprietary link-layer protocols, thereby enabling flexible deployment in diverse networking environments. Each port 758a-758n/760a-760n may dynamically switch between ingress and egress functionality or operate in dedicated ingress or egress modes, depending on an overall configuration and management policies configured via, for example, software or firmware.

In some aspects, each port 758a-758n/760a-760n may incorporate physical layer devices (PHYs) and/or logic that perform signal encoding/decoding, clock and data recovery, and other low-level operations. These components may be implemented in ASICs, FPGAs, or discrete modules. Ports may also include local buffers or queues, queues 762a-762n for wired ports and queues 764a-764n for wireless ports, to temporarily store data before switching. In certain implementations, the port-specific buffers or queue 762a-762n/764a-764n may be referred to as on-chip or external memory elements. The on-chip or external memory elements may work with larger shared resources, such as buffer 768, to provide efficient queuing and management of traffic. The configuration and operational status of each port 758a-758n/760a-760n, such as speed, duplex settings, or active/inactive state, may be monitored by the processing circuitry 770. Furthermore, ports 758a-758n/760a-760n may provide status indicators or counters (e.g., for packets transmitted or dropped) that can be accessed by higher-level software for analytics or troubleshooting. The ports 758a-758n/760a-760n may provide one or more interface points that connect the switch 756 to external devices, thereby enabling one or more traffic management, congestion management, and/or load balancing techniques described herein. In some aspects, one or more queues 762a-762n/764a-764n may be utilized for per-client buffering, traffic prioritization, MAC-layer retransmissions, and/or QoS and airtime fairness enforcement.

In some aspects, the one or more of the queues 762a-762n/764a-764n may be configured to temporarily hold data units (e.g., packets) awaiting transmission or processing. In some implementations, the one or more queues 762a-762n/764a-764n may be implemented in hardware as dedicated first-in-first-out (FIFO) buffers, circular buffers, or other structures capable of being dynamically partitioned. For example, in an implementation where the switch 756 supports multiple “PRIORITY LEVEL” , high-priority traffic (such as real-time video or voice data) may be assigned to a dedicated queue with expedited processing, while lower-priority data (such as background file transfers) may be placed in another queue with a best-effort service policy.

The number of queues 762a-762n/764a-764n can vary according to one or more configurations. For example, an implementation may assign a separate queue to each port 758a-758n/760a-760n. In other implementations, one or more queues 762a-762n/764a-764n may be allocated based on traffic classes, “PRIORITY LEVEL” , or virtual channels. In some aspects, one or more queues 762a-762n/764a-764n collectively perform flow-control tasks by absorbing bursts of incoming data and releasing them at a rate consistent with downstream capacity. For instance, in a data center environment running HPC applications, each queue 762a-762n/764a-764n may correspond to a particular “TRAFFIC TYPE”, such as compute, storage, or management, and selectively throttle certain types of traffic whenever multiple ports ramp up simultaneously. By grouping traffic this way, a system can process a burst of new data transmissions without saturating downstream resources.

In some aspects, the switching hardware 766 may include one or more integrated circuits, multiplexers, crossbar fabrics, or other data-forwarding components arranged to direct incoming data from a port (e.g., one or more ports 758a-758n/760a-760n) to one or more destination ports based on switching logic for Layer 2 forwarding and/or routing logic for Layer 3 processing. In some implementations, the switching hardware 766 may operate at line-rate speeds (i.e., processing packets at the maximum theoretical speed of the network interface), ensuring minimal latency while maintaining reliable throughput. The switching hardware 766 may incorporate dedicated forwarding tables or pipelines that analyze header information, such as media access control (MAC) addresses for Layer 2 switching, virtual local area network (VLAN) tags, or network-layer identifiers such as Internet Protocol (IP) addresses for Layer 3 routing, to determine how best to forward each data unit within the switch 756. In addition, the switching hardware 766 may utilize programmable match-action stages (i.e., processing pipeline stages that compare incoming packet fields against predefined patterns and execute corresponding actions), enabling adaptation to evolving network needs through software-defined updates. For instance, a reconfiguration of the switching hardware 766 may implement different flow-control strategies, advanced monitoring capabilities, or security filters without needing a redesign of the switching hardware 766.

The processing circuitry 770 may comprise one or more processors, microcontrollers, digital signal processors (DSPs), or dedicated ASIC blocks configured to manage system-level operations of the switch 756. In some implementations, the processing circuitry 770 may execute firmware stored in memory 772 to maintain routing tables, manage port configuration parameters (e.g., enabling or disabling specific ports 758a-758n/760a-760n), and apply quality-of-service policies. The processing circuitry 770 can interface with higher-level management tools, such as a network orchestration platform or a cloud-based controller, to convey telemetry data or receive updated resource management circuitry/logic on the fly. By offloading some decisions to the switching hardware 766, the processing circuitry 770 can remain available for more complex tasks, including congestion analytics, device configuration, and other diagnostic tasks (e.g., performing debugging of flow-control counters or verifying compliance with service-level agreements). Accordingly, the switch 756 can maintain a high level of throughput while still providing congestion management and adaptive routing functionality.

The switch 756 may include memory 772 that may utilize one or more storage technologies, such as DRAM, SRAM, TCAM, or flash. In some aspects, DRAM may store large routing tables or buffering data, SRAM could serve as high-speed scratchpads for real-time operations, while TCAM could facilitate rapid lookups for routing or security rules. Regardless of the specific technology, memory 772 can be used to make configuration parameters, firmware images, and runtime data structures readily accessible to the processing circuitry 770. In certain aspects, memory 772 may house a lightweight operating system or embedded software stack that manages hardware resources and provides an interface for remote configuration and updates. Moreover, memory 772 may enable virtualization capabilities, allowing multiple logical partitions (or “slices”) of the device to operate independently, which may be useful in large-scale data centers or cloud environments, where different tenants or workloads may need isolated resources and custom flow-control settings.

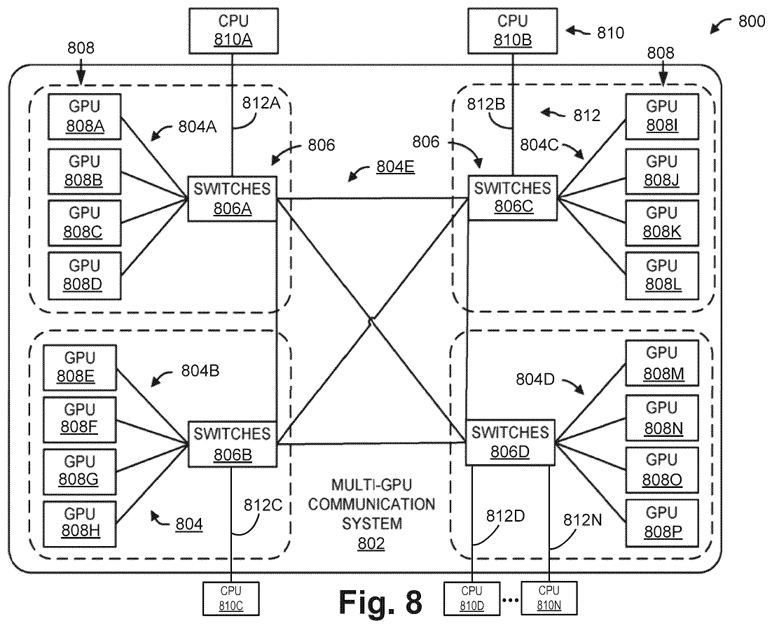

FIG. 8 illustrates a block diagram of an example system 800, in accordance with at least one embodiment. The system 800 may include, in at least one embodiment, one or more CPUs 810 connected to one or more multi-GPU communication systems (e.g., a multi-GPU communication system 802) by one or more signal conductors 812. In the embodiment illustrated in FIG. 8, the CPU(s) 810 include CPUs 810A, 810B, 810C, and 810D, which are connected to the multi-GPU communication system 802 by signal conductors 812A, 812B, 812C, and 812D, respectively. In some aspects, zero, one, or more CPUs (e.g., 810N) may be in communication with a switch (e.g., 806D) via one or more signal conductors 812N). In FIG. 8, the multi-GPU communication system 802 includes GPUs 808 connected to one another by at least one switch 806 and at least one signal conductor 804. In the embodiment illustrated, the switch(es) 806 include switches 806A-806D, the GPUs 808 include GPUs 808A-208P, and the signal conductor(s) 804 include signal conductors 804A-204E.

The system 800 may be characterized as being an example implementation of the system 700 (see FIG. 7A). For example, the CPU(s) 810 and/or the GPUs 808 may be implementations of the set 712 and/or the set 714. In at least one embodiment, the CPU(s) 810 may be substantially identical to the devices SD1-1 to SDM-X and/or the devices T1-TY. In at least one embodiment, the GPUs 808 may be substantially identical to the devices SD1-1 to SDM-X and/or the devices T1-TY. By way of another non-limiting example, the signal conductor(s) 804 and/or the signal conductor(s) 812 may be implementations of the signal conductors 716. In at least one embodiment, the signal conductor(s) 804 and/or the signal conductor(s) 812 may be substantially identical to the signal conductors 716. By way of yet another non-limiting example, the switch(es) 806 may be implementations of the internal switches IS1C1-ISMCN and/or the outbound switches OSW1-OSWN. In at least one embodiment, the switch(es) 806 may be substantially identical to the switches IS1C1-ISMCN (see FIG. 7A) and/or the outbound switches OSW1-OSWN.

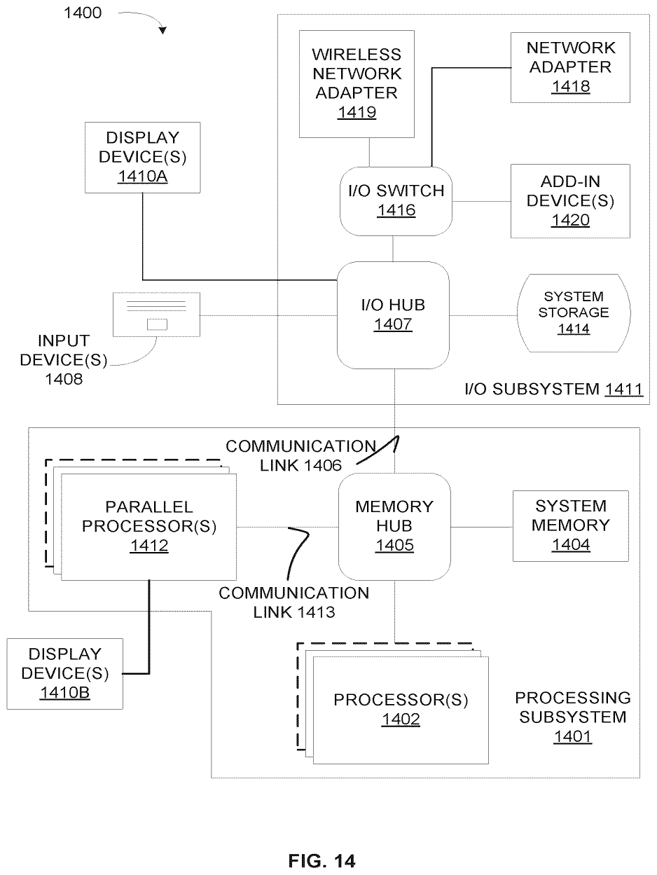

As a non-limiting example, the signal conductors 804 may link the GPUs 808 to the switch(es) 806, and the signal conductors 812A and 812B may link the at least one of the switch(es) 806 to one or more of the CPU(s) 810. As illustrated in FIG. 8, the CPUs 810A and 810B may connected to the switches 806A and 806C, respectively, by the signal conductors 812A and 812B, respectively. In at least one embodiment, one or more of the CPU(s) 810 may be implemented as a CPU 1600 illustrated in FIG. 16. One or more of the GPUs 808 may be implemented as one or more parallel processor(s) 1730 illustrated in FIG. 14.

The multi-GPU communication system 802 may implement a form of mesh networking, which may have a local area network topology in which infrastructure nodes or devices may be connected directly, dynamically, and non-hierarchically to other nodes and may cooperate with one another to efficiently route data. Examples of infrastructure devices may include bridges, the switch(es) 806, and/or other types of infrastructure devices. The multi-GPU communication system 802 may be referred to as a GPU-to-GPU System. By way of a non-limiting example, the multi-GPU communication system 802 may be implemented as a GPU-to-GPU link system (e.g., a NVLINK® GPU-to-GPU interconnect system) in which the switch(es) 806 may include one or more GPU-to-GPU switches (e.g., one or more NVSWITCH™ switches).

The switch 806A is connected to the GPUs 808A-208D by the signal conductors 804A, the switch 806B is connected to the GPUs 808E-808H by the signal conductors 804B, the switch 806C is connected to the GPUs 808I-808L by the signal conductors 804C, and the switch 806D is connected to the GPUs 808M-808P by the signal conductors 804D. The switches 806A-806D are connected to one another by signal conductors 804E. Each of the switch(es) 806 may act as a router and/or a connection between two endpoints within the system 800 for the duration of a dedicated connection. In at least one embodiment, one or more of the switch(es) 806 may be implemented using an on-node switch architecture (e.g., one or more NVSWITCH™ switches) that connects processing units (e.g., one or more GPUs, one or more CPUs, and/or one or more other types of processor) together. The system 800 may function as part of another system, such as a data center, which incorporates hardware, networking, software, and/or libraries, and executes applications, such applications perform inferences, for example by executing Artificial Intelligence (“AI”) or machine learning models.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. The systems and methods described herein may be used in augmented reality, virtual reality, mixed reality, robotics, security and surveillance, autonomous or semi-autonomous machine applications, and/or any other technology spaces in which one or more signal conductors may have at least two different states that consume different amounts of power.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, web-hosted services or web-hosted platforms, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, systems for implementing web-hosted services (e.g., for program optimization at runtime) or web-hosted platforms (e.g., integrated development environments that include program optimization as a service), as an application programming interface (“API”) between two or more separate applications or systems, and/or other types of systems.

### Data Center

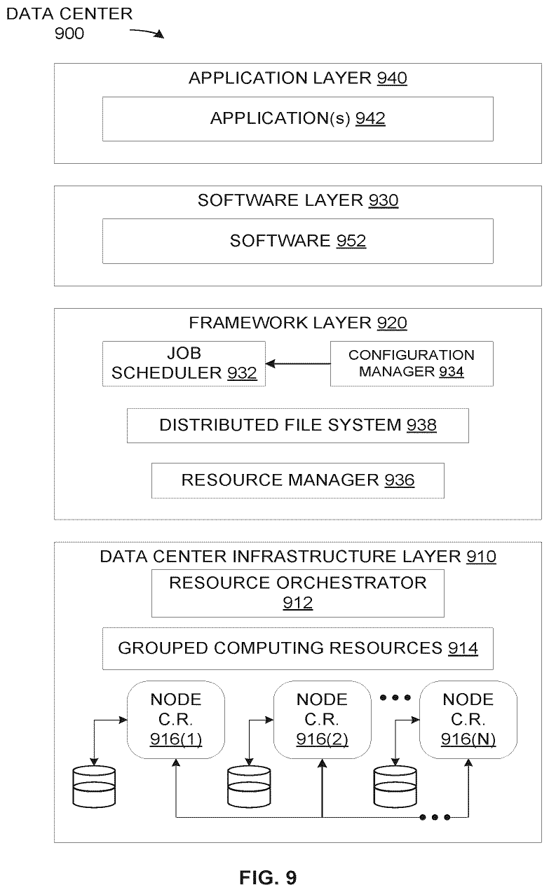

FIG. 9 illustrates an example data center 900, in accordance with at least one embodiment. In at least one embodiment, data center 900 includes, without limitation, a data center infrastructure layer 910, a framework layer 920, a software layer 930 and an application layer 940.

In at least one embodiment, as shown in FIG. 9, data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (“CPUs”) or other processors (including accelerators, field programmable gate arrays (“FPGAs”), data processing units (“DPUs”) in network devices, graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 916(1)-916(N) may be a server having one or more of above-mentioned computing resources.

In at least one embodiment, grouped computing resources 914 may include separate groupings of node C.R.s housed within one or more racks (not shown), or many racks housed in data centers at various geographical locations (also not shown). Separate groupings of node C.R.s within grouped computing resources 914 may include grouped compute, network, memory or storage resources that may be configured or allocated to support one or more workloads. In at least one embodiment, several node C.R. s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 912 may configure or otherwise control one or more node C.R.s 916(1)-916(N) and/or grouped computing resources 914. In at least one embodiment, resource orchestrator 912 may include a software design infrastructure (“SDI”) management entity for data center 900. In at least one embodiment, resource orchestrator 912 may include hardware, software or some combination thereof.

In at least one embodiment, as shown in FIG. 9, framework layer 920 includes, without limitation, a job scheduler 932, a configuration manager 934, a resource manager 936 and a distributed file system 938. In at least one embodiment, framework layer 920 may include a framework to support software 952 of software layer 930 and/or one or more application(s) 942 of application layer 940. In at least one embodiment, software 952 or application(s) 942 may respectively include web-based service software or applications, such as those provided by Amazon Web Services, Google Cloud and Microsoft Azure. In at least one embodiment, framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 932 may include a Spark driver to facilitate scheduling of workloads supported by various layers of data center 900. In at least one embodiment, configuration manager 934 may be capable of configuring different layers such as software layer 930 and framework layer 920, including Spark and distributed file system 938 for supporting large-scale data processing. In at least one embodiment, resource manager 936 may be capable of managing clustered or grouped computing resources mapped to or allocated for support of distributed file system 938 and job scheduler 932. In at least one embodiment, clustered or grouped computing resources may include grouped computing resource 914 at data center infrastructure layer 910. In at least one embodiment, resource manager 936 may coordinate with resource orchestrator 912 to manage these mapped or allocated computing resources.

In at least one embodiment, software 952 included in software layer 930 may include software used by at least portions of node C.R.s 916(1)-916(N), grouped computing resources 914, and/or distributed file system 938 of framework layer 920. One or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. In at least one or more types of applications may include, without limitation, CUDA applications.

In at least one embodiment, any of configuration manager 934, resource manager 936, and resource orchestrator 912 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poor performing portions of a data center.

In at least one embodiment, the data center 900 may be used to implement the system 700 (see FIG. 7) and/or the system 800 (see FIG. 8). For example, the first set 712 and/or the second set 714 may include one or more of the grouped computing resources 914 and/or one or more of the C.R.s 916(1)-916(N). In at least one embodiment, one or more systems depicted in FIG. 9 are utilized to implement one or more systems and/or processes such as those described in connection with FIGS. 1-8.

### Computer-based Systems

The following figures set forth, without limitation, example computer-based systems that can be used to implement at least one embodiment.

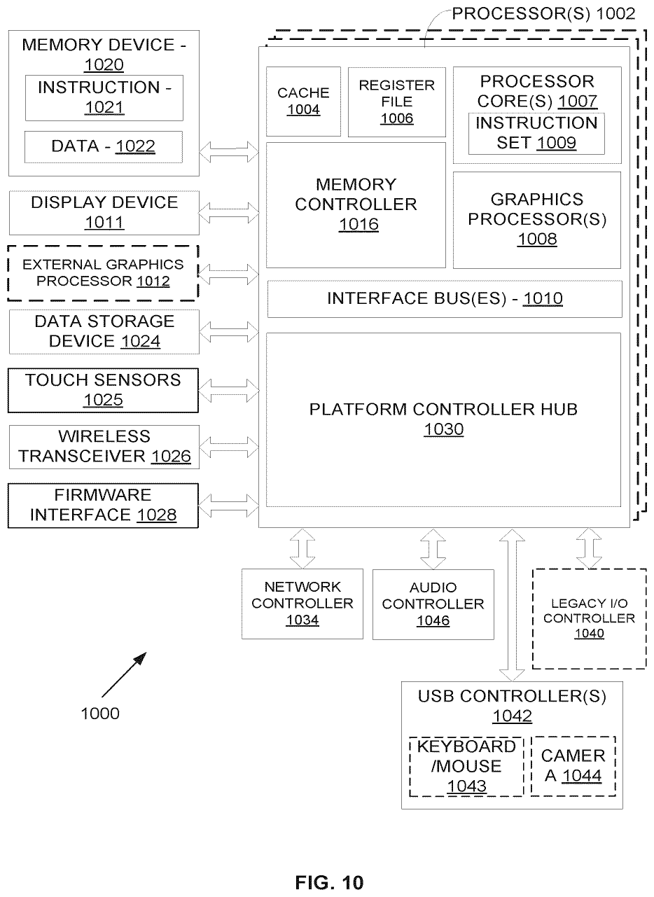

FIG. 10 illustrates a processing system 1000, in accordance with at least one embodiment. In at least one embodiment, processing system 1000 includes one or more processors 1002 and one or more graphics processors 1008, and may be a single processor desktop system, a multiprocessor workstation system, or a server system having a large number of processors 1002 or processor cores 1007. In at least one embodiment, processing system 1000 is a processing platform incorporated within a system-on-a-chip (“Sort”) integrated circuit for use in mobile, handheld, or embedded devices.

In at least one embodiment, processing system 1000 can include, or be incorporated within a server-based gaming platform, a game console, a media console, a mobile gaming console, a handheld game console, or an online game console. In at least one embodiment, processing system 1000 is a mobile phone, smart phone, tablet computing device or mobile Internet device. In at least one embodiment, processing system 1000 can also include, couple with, or be integrated within a wearable device, such as a smart watch wearable device, smart eyewear device, augmented reality device, or virtual reality device. In at least one embodiment, processing system 1000 is a television or set top box device having one or more processors 1002 and a graphical interface generated by one or more graphics processors 1008.

In at least one embodiment, one or more processors 1002 each include one or more processor cores 1007 to process instructions which, when executed, perform operations for system and user software. In at least one embodiment, each of one or more processor cores 1007 is configured to process a specific instruction set 1009. In at least one embodiment, instruction set 1009 may facilitate Complex Instruction Set Computing (“CISC”), Reduced Instruction Set Computing (“RISC”), or computing via a Very Long Instruction Word (“VLIW”). In at least one embodiment, processor cores 1007 may each process a different instruction set 1009, which may include instructions to facilitate emulation of other instruction sets. In at least one embodiment, processor core 1007 may also include other processing devices, such as a digital signal processor (“DSP”).

In at least one embodiment, processor 1002 includes cache memory (‘cache”) 1004. In at least one embodiment, processor 1002 can have a single internal cache or multiple levels of internal cache. In at least one embodiment, cache memory is shared among various components of processor 1002. In at least one embodiment, processor 1002 also uses an external cache (e.g., a Level 3 (“L3”) cache or Last Level Cache (“LLC”)) (not shown), which may be shared among processor cores 1007 using known cache coherency techniques. In at least one embodiment, register file 1006 is additionally included in processor 1002 which may include different types of registers for storing different types of data (e.g., integer registers, floating point registers, status registers, and an instruction pointer register). In at least one embodiment, register file 1006 may include general-purpose registers or other registers.

In at least one embodiment, one or more processor(s) 1002 are coupled with one or more interface bus(es) 1010 to transmit communication signals such as address, data, or control signals between processor 1002 and other components in processing system 1000. In at least one embodiment interface bus 1010, in one embodiment, can be a processor bus, such as a version of a Direct Media Interface (“DMI”) bus. In at least one embodiment, interface bus 1010 is not limited to a DMI bus and may include one or more Peripheral Component Interconnect buses (e.g., “PCI,” PCI Express (“PCIe”)), memory buses, or other types of interface buses. In at least one embodiment processor(s) 1002 include an integrated memory controller 1016 and a platform controller hub 1030. In at least one embodiment, memory controller 1016 facilitates communication between a memory device and other components of processing system 1000, while platform controller hub (“PCH”) 1030 provides connections to Input/Output (“I/O”) devices via a local I/O bus.

In at least one embodiment, memory device 1020 can be a dynamic random-access memory (“DRAM”) device, a static random-access memory (“SRAM”) device, flash memory device, phase-change memory device, or some other memory device having suitable performance to serve as processor memory. In at least one embodiment memory device 1020 can operate as system memory for processing system 1000, to store data 1022 and instructions 1021 for use when one or more processors 1002 executes an application or process. In at least one embodiment, memory controller 1016 also couples with an optional external graphics processor 1012, which may communicate with one or more graphics processors 1008 in processors 1002 to perform graphics and media operations. In at least one embodiment, a display device 1011 can connect to processor(s) 1002. In at least one embodiment display device 1011 can include one or more of an internal display device, as in a mobile electronic device or a laptop device or an external display device attached via a display interface (e.g., DisplayPort, etc.). In at least one embodiment, display device 1011 can include a head mounted display (“HMD”) such as a stereoscopic display device for use in virtual reality (“VR”) applications or augmented reality (“AR”) applications.

In at least one embodiment, platform controller hub 1030 enables peripherals to connect to memory device 1020 and processor 1002 via a high-speed I/O bus. In at least one embodiment, I/O peripherals include, but are not limited to, an audio controller 1046, a network controller 1034, a firmware interface 1028, a wireless transceiver 1026, touch sensors 1025, a data storage device 1024 (e.g., hard disk drive, flash memory, etc.). In at least one embodiment, data storage device 1024 can connect via a storage interface (e.g., SATA) or via a peripheral bus, such as PCI, or PCIe. In at least one embodiment, touch sensors 1025 can include touch screen sensors, pressure sensors, or fingerprint sensors. In at least one embodiment, wireless transceiver 1026 can be a Wi-Fi transceiver, a Bluetooth transceiver, or a mobile network transceiver such as a 3G, 4G, or Long Term Evolution (“LTE”) transceiver. In at least one embodiment, firmware interface 1028 enables communication with system firmware, and can be, for example, a unified extensible firmware interface (“UEFI”). In at least one embodiment, network controller 1034 can enable a network connection to a wired network. In at least one embodiment, a high-performance network controller (not shown) couples with interface bus 1010. In at least one embodiment, audio controller 1046 is a multi-channel high definition audio controller. In at least one embodiment, processing system 1000 includes an optional legacy I/O controller 1040 for coupling legacy (e.g., Personal System 2 (“PS/2”)) devices to processing system 1000. In at least one embodiment, platform controller hub 1030 can also connect to one or more Universal Serial Bus (“USB”) controllers 1042 connect input devices, such as keyboard and mouse 1043 combinations, a camera 1044, or other USB input devices.

In at least one embodiment, an instance of memory controller 1016 and platform controller hub 1030 may be integrated into a discreet external graphics processor, such as external graphics processor 1012. In at least one embodiment, platform controller hub 1030 and/or memory controller 1016 may be external to one or more processor(s) 1002. For example, in at least one embodiment, processing system 1000 can include an external memory controller 1016 and platform controller hub 1030, which may be configured as a memory controller hub and peripheral controller hub within a system chipset that is in communication with processor(s) 1002.

In at least one embodiment, the processing system 1000 may be used to implement the system 700 (see FIG. 7) and/or the system 800 (see FIG. 8). In at least one embodiment, the first set 712 and/or the second set 714 may include one or more of the processor(s) 1002, one or more of the processor core(s) 1007, and/or one or more of the graphics processor(s) 1008. In at least one embodiment, the interface bus 1010 may be used to implement the switching circuitry 710 (see FIG. 7), the bus(es) 728, and/or the signal conductors 734 and 740. In at least one embodiment, one or more systems depicted in FIG. 10 are utilized to implement one or more systems and/or processes such as those described in connection with FIGS. 1-8.

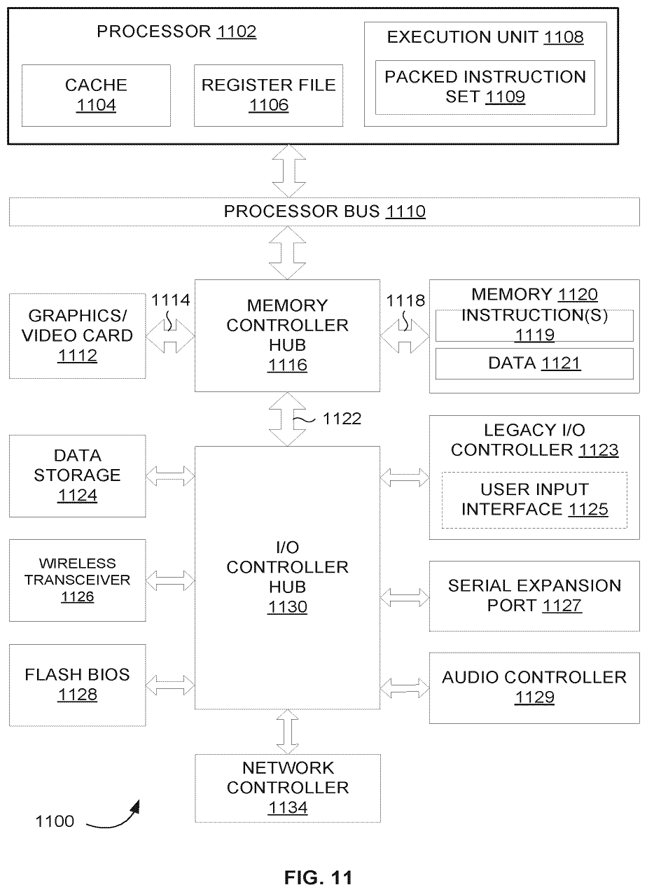

FIG. 11 illustrates a computer system 1100, in accordance with at least one embodiment. In at least one embodiment, computer system 1100 may be a system with interconnected devices and components, an SOC, or some combination. In at least on embodiment, computer system 1100 is formed with a processor 1102 that may include execution units to execute an instruction. In at least one embodiment, computer system 1100 may include, without limitation, a component, such as processor 1102 to employ execution units including logic to perform algorithms for processing data. In at least one embodiment, computer system 1100 may include processors, such as PENTIUM® Processor family, Xeon™, Itanium®, XScale™ and/or StrongArm™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 1100 may execute a version of WINDOWS′ operating system available from Microsoft Corporation of Redmond, Wash., although other operating systems (UNIX and Linux for example), embedded software, and/or graphical user interfaces, may also be used.

In at least one embodiment, computer system 1100 may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (DSP), an SoC, network computers (“Net PCs”), set-top boxes, network hubs, wide area network (“WAN”) switches, or any other system that may perform one or more instructions.

In at least one embodiment, computer system 1100 may include, without limitation, processor 1102 that may include, without limitation, one or more execution units 1108 that may be configured to execute a Compute Unified Device Architecture (“CUDA”) (CUDA® is developed by NVIDIA Corporation of Santa Clara, CA) program. In at least one embodiment, a CUDA program is at least a portion of a software application written in a CUDA programming language. In at least one embodiment, computer system 1100 is a single processor desktop or server system. In at least one embodiment, computer system 1100 may be a multiprocessor system. In at least one embodiment, processor 1102 may include, without limitation, a CISC microprocessor, a RISC microprocessor, a VLIW microprocessor, a processor implementing a combination of instruction sets, or any other processor device, such as a digital signal processor, for example. In at least one embodiment, processor 1102 may be coupled to a processor bus 1110 that may transmit data signals between processor 1102 and other components in computer system 1100.

In at least one embodiment, processor 1102 may include, without limitation, a Level 1 (“L1”) internal cache memory (“cache”) 1104. In at least one embodiment, processor 1102 may have a single internal cache or multiple levels of internal cache. In at least one embodiment, cache memory may reside external to processor 1102. In at least one embodiment, processor 1102 may also include a combination of both internal and external caches. In at least one embodiment, a register file 1106 may store different types of data in various registers including, without limitation, integer registers, floating point registers, status registers, and instruction pointer register.

In at least one embodiment, execution unit 1108, including, without limitation, logic to perform integer and floating point operations, also resides in processor 1102. Processor 1102 may also include a microcode (“ucode”) read only memory (“ROM”) that stores microcode for certain macro instructions. In at least one embodiment, execution unit 1108 may include logic to handle a packed instruction set 1109. In at least one embodiment, by including packed instruction set 1109 in an instruction set of a general-purpose processor 1102, along with associated circuitry to execute instructions, operations used by many multimedia applications may be performed using packed data in a general-purpose processor 1102. In at least one embodiment, many multimedia applications may be accelerated and executed more efficiently by using full width of a processor's data bus for performing operations on packed data, which may eliminate a need to transfer smaller units of data across a processor's data bus to perform one or more operations one data element at a time.

In at least one embodiment, execution unit 1108 may also be used in microcontrollers, embedded processors, graphics devices, DSPs, and other types of logic circuits. In at least one embodiment, computer system 1100 may include, without limitation, a memory 1120. In at least one embodiment, memory 1120 may be implemented as a DRAM device, an SRAM device, flash memory device, or other memory device. Memory 1120 may store instruction(s) 1119 and/or data 1121 represented by data signals that may be executed by processor 1102.

In at least one embodiment, a system logic chip may be coupled to processor bus 1110 and memory 1120. In at least one embodiment, the system logic chip may include, without limitation, a memory controller hub (“MCH”) 1116, and processor 1102 may communicate with MCH 1116 via processor bus 1110. In at least one embodiment, MCH 1116 may provide a high bandwidth memory path 1118 to memory 1120 for instruction and data storage and for storage of graphics commands, data and textures. In at least one embodiment, MCH 1116 may direct data signals between processor 1102, memory 1120, and other components in computer system 1100 and to bridge data signals between processor bus 1110, memory 1120, and a system I/O 1122. In at least one embodiment, system logic chip may provide a graphics port for coupling to a graphics controller. In at least one embodiment, MCH 1116 may be coupled to memory 1120 through high bandwidth memory path 1118 and graphics/video card 1112 may be coupled to MCH 1116 through an Accelerated Graphics Port (“AGP”) interconnect 1114.

In at least one embodiment, computer system 1100 may use system I/O 1122 that is a proprietary hub interface bus to couple MCH 1116 to I/O controller hub (“ICH”) 1130. In at least one embodiment, ICH 1130 may provide direct connections to some I/O devices via a local I/O bus. In at least one embodiment, local I/O bus may include, without limitation, a high-speed I/O bus for connecting peripherals to memory 1120, a chipset, and processor 1102. Examples may include, without limitation, an audio controller 1129, a firmware hub (“flash BIOS”) 1128, a wireless transceiver 1126, a data storage 1124, a legacy I/O controller 1123 containing a user input interface 1125 and a keyboard interface, a serial expansion port 1127, such as a USB, and a network controller 1134. Data storage 1124 may comprise a hard disk drive, a floppy disk drive, a CD-ROM device, a flash memory device, or other mass storage device.

In at least one embodiment, FIG. 11 illustrates a system, which includes interconnected hardware devices or “chips.” In at least one embodiment, FIG. 11 may illustrate an example SoC. In at least one embodiment, devices illustrated in FIG. 11 may be interconnected with proprietary interconnects, standardized interconnects (e.g., PCIe), or some combination thereof. In at least one embodiment, one or more components of system 1100 are interconnected using compute express link (“CXL”) interconnects.

In at least one embodiment, the computer system 1100 may be used to implement the system 700 (see FIG. 7) and/or the system 800 (see FIG. 8). In at least one embodiment, the first set 712 and/or the second set 714 may include the processor 1102 and/or the graphics/video card 1112. In at least one embodiment, the processor bus 1110 may be used to implement the switching circuitry 710 (see FIG. 7), the bus(es) 728, and/or the signal conductors 734 and 740. In at least one embodiment, one or more systems depicted in FIG. 11 are utilized to implement one or more systems and/or processes such as those described in connection with FIGS. 1-8.

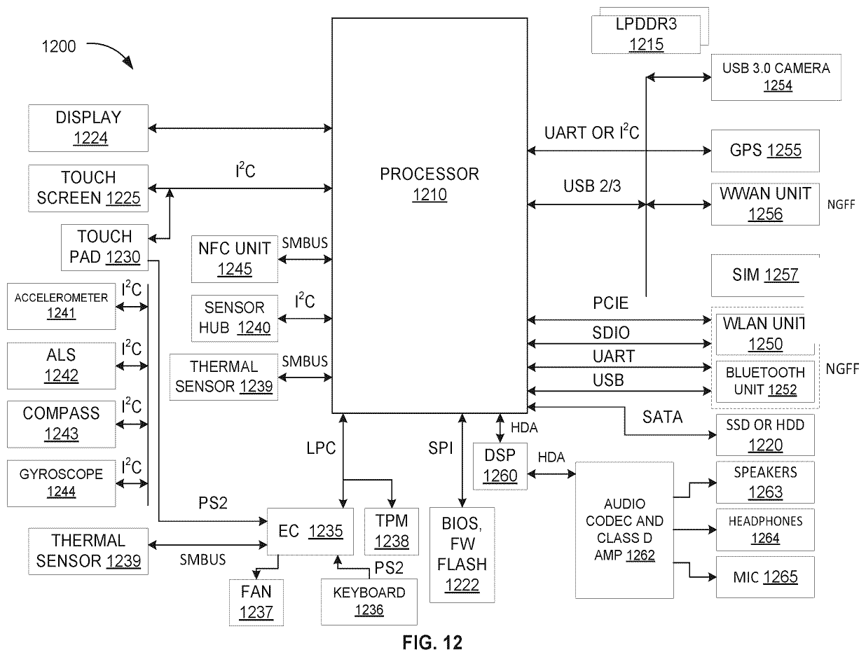

FIG. 12 illustrates a system 1200, in accordance with at least one embodiment. In at least one embodiment, system 1200 is an electronic device that utilizes a processor 1210. In at least one embodiment, system 1200 may be, for example and without limitation, a notebook, a tower server, a rack server, a blade server, an edge device communicatively coupled to one or more on-premise or cloud service providers, a laptop, a desktop, a tablet, a mobile device, a phone, an embedded computer, or any other suitable electronic device.

In at least one embodiment, system 1200 may include, without limitation, processor 1210 communicatively coupled to any suitable number or kind of components, peripherals, modules, or devices. In at least one embodiment, processor 1210 is coupled using a bus or interface, such as an I2C bus, a System Management Bus (“SMBus”), a Low Pin Count (“LPC”) bus, a Serial Peripheral Interface (“SPI”), a High Definition Audio (“HDA”) bus, a Serial Advance Technology Attachment (“SATA”) bus, a USB (versions 1, 2, 3) , or a Universal Asynchronous Receiver/Transmitter (“UART”) bus. In at least one embodiment, FIG. 12 illustrates a system which includes interconnected hardware devices or “chips.” In at least one embodiment, FIG. 12 may illustrate an example SoC. In at least one embodiment, devices illustrated in FIG. 12 may be interconnected with proprietary interconnects, standardized interconnects (e.g., PCIe) or some combination thereof. In at least one embodiment, one or more components of FIG. 12 are interconnected using CXL interconnects.

In at least one embodiment, FIG. 12 may include a display 1224, a touch screen 1225, a touch pad 1230, a Near Field Communications unit (“NFC”) 1245, a sensor hub 1240, a thermal sensor 1246, an Express Chipset (“EC”) 1235, a Trusted Platform Module (“TPM”) 1238, BIOS/firmware/flash memory (“BIOS, FW Flash”) 1222, a DSP 1260, a Solid State Disk (“SSD”) or Hard Disk Drive (“HDD”) 1220, a wireless local area network unit (“WLAN”) 1250, a Bluetooth unit 1252, a Wireless Wide Area Network unit (“WWAN”) 1256, a Global Positioning System (“GPS”) 1255, a camera (“USB 3.0 camera”) 1254 such as a USB 3.0 camera, or a Low Power Double Data Rate (“LPDDR”) memory unit (“LPDDR3”) 1215 implemented in, for example, LPDDR3 standard. These components may each be implemented in any suitable manner.

In at least one embodiment, other components may be communicatively coupled to processor 1210 through components discussed above. In at least one embodiment, an accelerometer 1241, an Ambient Light Sensor (“ALS”) 1242, a compass 1243, and a gyroscope 1244 may be communicatively coupled to sensor hub 1240. In at least one embodiment, a thermal sensor 1239, a fan 1237, a keyboard 1236, and a touch pad 1230 may be communicatively coupled to EC 1235. In at least one embodiment, a speaker 1263, a headphones 1264, and a microphone (“mic”) 1265 may be communicatively coupled to an audio unit (“audio codec and class d amp”) 1262, which may in turn be communicatively coupled to DSP 1260. In at least one embodiment, audio unit 1262 may include, for example and without limitation, an audio coder/decoder (“codec”) and a class D amplifier. In at least one embodiment, a SIM card (“SIM”) 1257 may be communicatively coupled to WWAN unit 1256. In at least one embodiment, components such as WLAN unit 1250 and Bluetooth unit 1252, as well as WWAN unit 1256 may be implemented in a Next Generation Form Factor (“NGFF”).

In at least one embodiment, the system 1200 may be used to implement the system 700 (see FIG. 7) and/or the system 800 (see FIG. 8). In at least one embodiment, a processor 722 (see FIG. 7) may be implemented using the processor 1210. In at least one embodiment, one or more systems depicted in FIG. 12 are utilized to implement one or more systems and/or processes such as those described in connection with FIGS. 1-8.

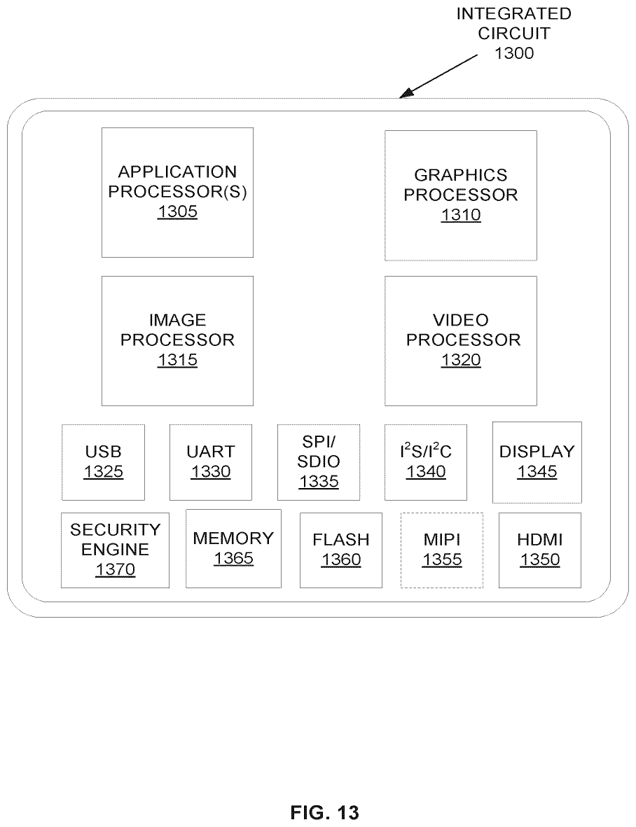

FIG. 13 illustrates an example integrated circuit 1300, in accordance with at least one embodiment. In at least one embodiment, example integrated circuit 1300 is an SoC that may be fabricated using one or more IP cores. In at least one embodiment, integrated circuit 1300 includes one or more application processor(s) 1305 (e.g., CPUs, DPUs), at least one graphics processor 1310, and may additionally include an image processor 1315 and/or a video processor 1320, any of which may be a modular IP core. In at least one embodiment, integrated circuit 1300 includes peripheral or bus logic including a USB controller 1325, a UART controller 1330, an SPI/SDIO controller 1335, and an I2S/I2C controller 1340. In at least one embodiment, integrated circuit 1300 can include a display device 1345 coupled to one or more of a high-definition multimedia interface (“HDMI”) controller 1350 and a mobile industry processor interface (“MIPI”) display interface 1355. In at least one embodiment, storage may be provided by a flash memory subsystem 1360 including flash memory and a flash memory controller. In at least one embodiment, a memory interface may be provided via a memory controller 1365 for access to SDRAM or SRAM memory devices. In at least one embodiment, some integrated circuits additionally include an embedded security engine 1370.

In at least one embodiment, the integrated circuit 1300 may be used to implement the system 700 (see FIG. 7) and/or the system 800 (see FIG. 8). In at least one embodiment, the first set 712 and/or the second set 714 may include one or more of the application processor(s) 1305, one or more of the graphics processor(s) 1310, the image processor 1315, and/or the video processor 1320. Referring to FIG. 7, in at least one embodiment, the peripheral or bus logic of the integrated circuit 1300 (see FIG. 13) may be used to implement the switching circuitry 710 (see FIG. 7), the bus(es) 728, and/or the signal conductors 734 and 740.

FIG. 14 illustrates a computing system 1400, according to at least one embodiment; In at least one embodiment, computing system 1400 includes a processing subsystem 1401 having one or more processor(s) 1402 and a system memory 1404 communicating via an interconnection path that may include a memory hub 1405. In at least one embodiment, memory hub 1405 may be a separate component within a chipset component or may be integrated within one or more processor(s) 1402. In at least one embodiment, memory hub 1405 couples with an I/O subsystem 1411 via a communication link 1406. In at least one embodiment, I/O subsystem 1411 includes an I/O hub 1407 that can enable computing system 1400 to receive input from one or more input device(s) 1408. In at least one embodiment, I/O hub 1407 can enable a display controller, which may be included in one or more processor(s) 1402, to provide outputs to one or more display device(s) 1410A. In at least one embodiment, one or more display device(s) 1410A coupled with I/O hub 1407 can include a local, internal, or embedded display device.

In at least one embodiment, processing subsystem 1401 includes one or more parallel processor(s) 1412 coupled to memory hub 1405 via a bus or other communication link 1413. In at least one embodiment, communication link 1413 may be one of any number of standards based communication link technologies or protocols, such as, but not limited to PCIe, or may be a vendor specific communications interface or communications fabric. In at least one embodiment, one or more parallel processor(s) 1412 form a computationally focused parallel or vector processing system that can include a large number of processing cores and/or processing clusters, such as a many integrated core processor. In at least one embodiment, one or more parallel processor(s) 1412 form a graphics processing subsystem that can output pixels to one of one or more display device(s) 1410A coupled via I/O Hub 1407. In at least one embodiment, one or more parallel processor(s) 1412 can also include a display controller and display interface (not shown) to enable a direct connection to one or more display device(s) 1410B.

In at least one embodiment, a system storage unit 1414 can connect to I/O hub 1407 to provide a storage mechanism for computing system 1400. In at least one embodiment, an I/O switch 1416 can be used to provide an interface mechanism to enable connections between I/O hub 1407 and other components, such as a network adapter 1418 and/or wireless network adapter 1419 that may be integrated into a platform, and various other devices that can be added via one or more add-in device(s) 1420. In at least one embodiment, network adapter 1418 can be an Ethernet adapter or another wired network adapter. In at least one embodiment, wireless network adapter 1419 can include one or more of a Wi-Fi, Bluetooth, NFC, or other network device that includes one or more wireless radios.

In at least one embodiment, computing system 1400 can include other components not explicitly shown, including USB or other port connections, optical storage drives, video capture devices, and the like, that may also be connected to I/O hub 1407. In at least one embodiment, communication paths interconnecting various components in FIG. 14 may be implemented using any suitable protocols, such as PCI based protocols (e.g., PCIe), or other bus or point-to-point communication interfaces and/or protocol(s), such as NVLink™ high-speed interconnect, or interconnect protocols.

In at least one embodiment, one or more parallel processor(s) 1412 incorporate circuitry optimized for graphics and video processing, including, for example, video output circuitry, and constitutes a graphics processing unit (“GPU”). In at least one embodiment, one or more parallel processor(s) 1412 incorporate circuitry optimized for general purpose processing. In at least embodiment, components of computing system 1400 may be integrated with one or more other system elements on a single integrated circuit. For example, in at least one embodiment, one or more parallel processor(s) 1412, memory hub 1405, processor(s) 1402, and I/O hub 1407 can be integrated into an SoC integrated circuit. In at least one embodiment, components of computing system 1400 can be integrated into a single package to form a system in package (“SIP”) configuration. In at least one embodiment, at least a portion of the components of computing system 1400 can be integrated into a multi-chip module (“MCM”), which can be interconnected with other multi-chip modules into a modular computing system. In at least one embodiment, I/O subsystem 1411 and display devices 1410B are omitted from computing system 1400.

In at least one embodiment, the computing system 1400 may be used to implement the system 700 (see FIG. 7) and/or the system 800 (see FIG. 8). In at least one embodiment, the first set 712 and/or the second set 714 may include one or more of the processor(s) 1402 and/or one or more of the one or more parallel processor(s) 1412. In at least one embodiment, the communication link 1413 may be used to implement the switching circuitry 710 (see FIG. 7), the bus(es) 728, and/or the signal conductors 734 and 740.

It should be noted that, while example embodiments described herein may relate to a CUDA programming model, techniques described herein can be utilized with any suitable programming model, such HIP, oneAPI (e.g., using oneAPI-based programming to perform or implement a method disclosed herein), and/or variations thereof.

In at least one embodiment, one or more components of systems and/or processors disclosed above can communicate with one or more CPUs, ASICs, GPUs, FPGAs, or other hardware, circuitry, or integrated circuit components that include, e.g., an upscaler or upsampler to upscale an image, an image blender or image blender component to blend, mix, or add images together, a sampler to sample an image (e.g., as part of a DSP), a neural network circuit that is configured to perform an upscaler to upscale an image (e.g., from a low resolution image to a high resolution image), or other hardware to modify or generate an image, frame, or video to adjust its resolution, size, or pixels; one or more components of systems and/or processors disclosed above can use components described in this disclosure to perform methods, operations, or instructions that generate or modify an image.

It is to be appreciated that any feature described herein can be claimed in combination with any other feature(s) as described herein, regardless of whether the features come from the same described embodiment.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art. It is to be appreciated that any feature described herein can be claimed in combination with any other feature(s) as described herein, regardless of whether the features come from the same described embodiment.

What is claimed is:

1. A network interface device comprising:
an optical interface to communicate data via an optical communication medium;
a wireless interface to communicate data via a wireless communication medium; and
one or more circuits to selectively route data from a host device to at least one of the optical interface or the wireless interface in response to a threshold condition.

2. The network interface device of claim 1, wherein the one or more circuits are further to at least one of:
switch data transmission from a first communication medium to a second communication medium; or
enable both communication media concurrently.

3. The network interface device of claim 1, wherein the one or more circuits are further to route data via both the optical interface and the wireless interface in response to the threshold condition.

4. The network interface device of claim 1, wherein the threshold condition is based on at least one of:
a measured communication link quality metric associated with at least one of the optical communication medium or the wireless communication medium;
a measure of bandwidth utilization associated with at least one of the optical communication medium or the wireless communication medium;
a detected bit-error rate associated with at least one of the optical communication medium or the wireless communication medium; or
a signal-to-noise ratio associated with at least one of the optical communication medium or the wireless communication medium.

5. The network interface device of claim 1, wherein the one or more circuits are further to:
receive an indication of a workload demand; and
compare the indication of the workload demand to the threshold condition.

6. The network interface device of claim 5, wherein the one or more circuits are further to:
route high-priority workload traffic through the optical interface; and
route lower-priority workload traffic through the wireless interface.

7. The network interface device of claim 1, wherein the one or more circuits include a local memory storing artificial intelligence (AI)-based decision logic, and the threshold condition is determined by the AI-based decision logic in response to usage metrics collected from the optical interface and the wireless interface.

8. The network interface device of claim 1, wherein the threshold condition is triggered in response to receiving a switching command from an external orchestration controller in a data center network.

9. The network interface device of claim 1, further comprising a coupling interface to couple the network interface device to the host device, wherein the coupling interface is further to communicate with the host device using at least one of an optical pathway or an electrical pathway.

10. The network interface device of claim 1, wherein the wireless interface comprises at least one of:
a photonic mixing stage to generate optical signal; or
a radio frequency mixing stage configured to generate or receive millimeter-wave or terahertz signals.

11. The network interface device of claim 1, further comprising:
a photonic signal generator to generate a modulated optical signal; and
a branching module to direct the modulated optical signal to at least one of the optical interface or the wireless interface.

12. The network interface device of claim 11, further comprising an optical output coupling the modulated optical signal to an optical fiber.

13. The network interface device of claim 12, wherein the wireless interface includes:
a photonic mixing stage to generate a millimeter-wave or terahertz signals; and
an antenna coupled to the photonic mixing stage.

14. The network interface device of claim 1, wherein the one or more circuits are to adaptively adjust operation of the network interface device based on at least one of real-time network conditions or workload demands, including at least one of modifying data routing logic, selecting between communication media, or reallocating bandwidth across the optical interface and the wireless interface.

15. A network interface device comprising:
an optical interface to receive a modulated optical signal;
optical processing circuitry to demodulate the modulated optical;
a wireless interface to receive a wireless signal;
wireless processing circuitry to decode the wireless signal; and
one or more output circuits coupled to the optical processing circuitry and the wireless processing circuitry, the one or more output circuits to provide demodulated data to a host system.

16. The network interface device of claim 15, further comprising controller communicatively coupled to the optical processing circuitry and the wireless processing circuitry, the controller to:
monitor at least one link-quality metric associated with the optical interface and the wireless interface; and
selectively enable or disable reception through at least one of the optical interface or wireless interface based on a threshold condition.

17. The network interface device of claim 16, wherein the controller is further to receive data concurrently over the optical interface and the wireless interface in response to detecting that at least one of an overall bandwidth demand or a link utilization meets or exceeds the threshold condition.

18. The network interface device of claim 16, wherein the controller comprises artificial intelligence (AI)-based decision logic to modify the threshold condition based on the at least one link-quality metric.

19. A system comprising:
a host device to generate outgoing data traffic;
a network interface device communicatively coupled to the host device, the network interface device comprising:
an optical interface to transmit data over an optical communication medium,
a wireless interface to transmit data over a wireless communication medium, and
a controller to selectively route the outgoing data traffic between the optical interface and the wireless interface based on a threshold condition.

20. The system of claim 19, wherein the network interface device further comprises:
optical processing circuitry to demodulate inbound optical signals from the optical communication medium; and
wireless processing circuitry to decode inbound wireless signals from the wireless communication medium, and wherein the controller is further to route incoming data to the host device.

21. The system of claim 20, wherein the controller comprises an artificial intelligence module to:
monitor link performance metrics from the optical interface and the wireless interface; and
dynamically adjust the threshold condition in response to changes in the link performance metrics.

22. The system of claim 19, wherein the host device comprises a workload manager that assigns a priority indicator to outgoing data, and the controller is to route higher-priority traffic over the optical interface and lower-priority traffic over the wireless interface.

23. A hybrid network switch comprising:
a plurality of wired ports to transmit and receive data over physical cabling;
a plurality of wireless ports to transmit and receive data over a wireless communication medium; and
switching hardware coupled to the plurality of wired ports and the plurality of wireless ports, the switching hardware to direct data from an ingress port to a selected egress port based on routing or switching logic.
